(19) United States
(12) Patent Application Publication
(10) Pub. No.: US 2016/0358181 A1
(43) Pub. Date: Dec. 8, 2016

(54) AUGMENTED REALITY SYSTEMS AND METHODS FOR TRACKING BIOMETRIC DATA

(71) Applicant: Magic Leap, Inc., Dania Beach, FL (US)

(72) Inventor: Gary R. Bradski, Palo Alto, CA (US)

(73) Assignee: Magic Leap, Inc., Dania Beach, FL (US)

(21) Appl. No.: 15/155,013

(22) Filed: May 14, 2016

Related U.S. Application Data
(60) Provisional application No. 62/161,588, filed on May 14, 2015.

(51) Int. Cl. G06Q 20/40; G06K 9/00; G06F 3/01; H04L 29/06

(52) U.S. Cl. CPC G06Q 20/40145; H04L 63/0861; G06K 9/00892; G06K 9/00617; G06F 3/013; G06K 9/00335

(57) ABSTRACT

A method of conducting a transaction through an augmented reality display device comprises capturing biometric data from a user, determining, based at least in part on the captured biometric data, an identity of the user, and authenticating the user for the transaction based on the determined identity.

### CROSS-REFERENCE TO RELATED APPLICATION(S)

This application claims priority to U.S. Provisional Application Ser. No. 62/161,665 filed on May 14, 2015 entitled “AUGMENTED REALITY SYSTEMS AND METHOD FOR TRACKING BIOMETRIC DATA TO CONDUCT BUSINESS TRANSACTIONS,” under attorney docket number ML.30027.00. The contents of the aforementioned patent application are hereby expressly incorporated by reference in its entirety for all purposes as through set forth in full.

### FIELD OF THE INVENTION

The present disclosure relates to systems and methods for utilizing biometric data to facilitate business transactions conducted through an augmented reality (AR) device.

### BACKGROUND

Modern computing and display technologies have facilitated the development of systems for so called “virtual reality” or “augmented reality” experiences, wherein digitally reproduced images or portions thereof are presented to a user in a manner wherein they seem to be, or may be perceived as, real. A virtual reality, or “VR”, scenario typically involves presentation of digital or virtual image information without transparency to other actual real-world visual input. An augmented reality, or “AR”, scenario typically involves presentation of digital or virtual image information as an augmentation to visualization of the actual world around the user.

For example, referring to FIG. 1, an augmented reality scene is depicted wherein a user of an AR technology sees a real-world park-like setting featuring people, trees, buildings in the background, and a concrete platform 1120. In addition to these items, the user of the AR technology also perceives a robot statue 1110 standing upon the real-world platform 1120, and a cartoon-like avatar character 2 flying by, even though these elements (2, 1110) do not exist in the real world. The human visual perception system is very complex, and producing such an augmented reality scene that facilitates a comfortable, natural-feeling, rich presentation of virtual image elements amongst other virtual or real-world imagery elements is challenging.

It is envisioned that such an AR device may be used to present all types of virtual content to the user. In one or more embodiments, the AR devices may be used in the context of various gaming applications, enabling users to participate in single-player or multi-player video/augmented reality games that mimic real-life situations. For example, rather than playing a video game at a personal computer, the AR user may play the game on a larger scale in conditions that very closely resemble real life (e.g., “true-to-scale” 3D monsters may appear from behind a real building when the AR user is taking a walk in the park, etc.). Indeed, this greatly enhances the believability and enjoyment of the gaming experience.

While FIG. 1 illustrates the possibility of AR devices in the context of gaming applications, AR devices may be used in a myriad of other applications, and may be anticipated to take the place of everyday computing devices (e.g., personal computers, cell phones, tablet devices etc.). By strategically placing virtual content in the field of view of the user, the AR device may be thought of as a walking personal computer that allows the user to perform a variety of computing tasks (e.g., check email, look up a term on the web, tele-conference with other AR users, watch a movie, etc.) while at the same time being connected to the user's physical environment. For example, rather than being constrained to a physical device at a desk, the AR user may be “on the go” (e.g., on a walk, on a daily commute, at a physical location other than his/her office, be away from his/her computer, etc.), but still be able to pull up a virtual email screen to check email, for example, or have a video conference with a friend by virtually populating a screen on the AR device, or in another example, be able to construct a virtual office at a make-shift location. A myriad of similar virtual reality/augmented reality scenarios may be envisioned.

This shift in the nature of the underlying computing technology comes with its share of advantages and challenges. To present an augmented reality scene such as the ones described above that is sensitive to the physiological limitations of the human visual system, the AR device must be aware of the user's physical surroundings in order to project desired virtual content in relation to one or more real objects in the user's physical environment. To this end, the AR device is typically equipped with various tracking devices (e.g., eye-tracking devices, GPS, etc.), cameras (e.g., field-of view cameras, infrared cameras, depth cameras, etc.) and sensors (e.g., accelerometers, gyroscopes, etc.) to assess the user's position, orientation, distance, etc. in relation to various real objects in the user's surroundings, to detect and identify objects of the real world and other such functionalities.

Given that the AR device is configured to track various types of data about the AR user and his/her surroundings, in one or more embodiments, this data may be advantageously leveraged to assist users with various types of transactions, while ensuring that minimal input is required from the user, and causing minimal or no interruption to the user's AR experience.

To elaborate, traditional transactions (financial or otherwise) typically require users to physically carry some form of monetary token (e.g., cash, check, credit card, etc.) and in some cases, identification (e.g., driver's license, etc.) and authentication (e.g., signature, etc.) to partake in business transactions. Consider a user walking into a department store: to make any kind of purchase, the user typically picks up the item(s), places the item in a cart, walks over to the register, waits in line for the cashier, waits for the cashier to scan a number of items, retrieves a credit card, provides identification, signs the credit card receipt, and stores the receipt for a future return of the item(s). In traditional financial transactions, these steps, although necessary, are time-consuming and inefficient, and in some cases discourage or prohibit a user from making a purchase (e.g., the user does not have the monetary token on his person or the identification card on his person, etc.). However, in the context of AR devices, these steps are redundant and unnecessary. In one or more embodiments, the AR devices may be configured to allow users to seamlessly perform many types of transactions without requiring the user to perform the onerous procedures described above.

There, thus, is a need for a better solution to assist AR users to participate in everyday transactions.

### SUMMARY

Embodiments of the present invention are directed to devices, systems and methods for facilitating virtual reality and/or augmented reality interaction for one or more users.

In one aspect, a method of conducting a transaction through an augmented reality device comprises capturing biometric data from a user, determining, based at least in part on the captured biometric data, an identity of the user, and authenticating the user for the transaction based on the determined identity.

In one or more embodiments, the method further comprises transmitting a set of data regarding the transaction to a financial institution. In one or more embodiments, the biometric data is an iris pattern. In one or more embodiments, the biometric data is a voice recording of the user. In one or more embodiments, the biometric data is a retinal signature. In one or more embodiments, the biometric data is a characteristic associated with the user's skin.

In one or more embodiments, the biometric data is captured through one or more eye tracking cameras that capture a movement of the user's eyes. In one or more embodiments, the biometric data is a pattern of movement of the user's eyes. In one or more embodiments, the biometric data is a blinking pattern of the user's eyes.

In one or more embodiments, the augmented reality device is head mounted, and the augmented reality device is individually calibrated for the user. In one or more embodiments, the biometric data is compared to a predetermined data pertaining to the user. In one or more embodiments, the predetermined data is a known signature movement of the user's eyes.

In one or more embodiments, the predetermined data is a known iris pattern. In one or more embodiments, the predetermined data is a known retinal pattern. In one or more embodiments, the method further comprises detecting a desire of the user to make a transaction, requesting the biometric data from the user based at least in part on the detected desire, and comparing the biometric data with a predetermined biometric data to generate a result, wherein the user is authenticated based at least in part on the result.

In one or more embodiments, the transaction is a business transaction. In one or more embodiments, the method further comprises communicating an authentication of the user to a financial institution associated with the user, wherein the financial institution releases payment on behalf of the user based at least in part on the authentication. In one or more embodiments, the financial institution transmits the payment to one or more vendors indicated by the user.

In one or more embodiments, the method further comprises detecting an interruption event or transaction event associated with the augmented reality device. In one or more embodiments, capturing new biometric data from the user in order to re-authenticate the user based at least in part on the detected event. In one or more embodiments, the interruption of activity is detected based at least in part on a removal of the augmented reality device from the user's head.

In one or more embodiments, the interruption of activity is detected based at least in part on a loss of connectivity of the augmented reality device with a network. In one or more embodiments, the transaction event is detected based at least in part on an express approval of a transaction by the user. In one or more embodiments, the transaction event is detected based at least in part on a heat map associated with the user's gaze.

In one or more embodiments, the transaction event is detected based at least in part on user input received through the augmented reality device. In one or more embodiments, the user input comprises an eye gesture. In one or more embodiments, the user input comprises a hand gesture.

In another aspect, an augmented reality display system comprises a biometric data tracking device to capture biometric data from a user, a processor operatively coupled to the biometric data tracking device to process the captured biometric data, and to determine an identity of the user based at least in part on the captured biometric data, and a server to communicate with at least a financial institution to authenticate the user for a transaction.

In one or more embodiments, the biometric data is eye movement data. In one or more embodiments, the biometric data corresponds to an image of an iris of the user. In one or more embodiments, the server also transmits a set of data regarding the transaction to a financial institution. In one or more embodiments, the biometric data is an iris pattern.

In one or more embodiments, the biometric data is a voice recording of the user. In one or more embodiments, the biometric data is a retinal signature. In one or more embodiments, the biometric data is a characteristic associated with the user's skin. In one or more embodiments, the biometric tracking device comprises one or more eye tracking cameras to capture a movement of the user's eyes. In one or more embodiments, the biometric data is a pattern of movement of the user's eyes.

In one or more embodiments, the biometric data is a blinking pattern of the user's eyes. In one or more embodiments, the augmented reality display system is head mounted, and the augmented reality display system is individually calibrated for the user. In one or more embodiments, the processor also compares the biometric data to a predetermined data pertaining to the user. In one or more embodiments, the predetermined data is a known signature movement of the user's eyes. In one or more embodiments, the predetermined data is a known iris pattern. In one or more embodiments, the predetermined data is a known retinal pattern. In one or more embodiments, the processor detects that a user desires to make a transaction, and further comprising a user interface to request the biometric data from the user based at least in part on the detection, the processor comparing the biometric data with a predetermined biometric data, and authenticating the user based at least in part on the comparison.

In one or more embodiments, the transaction is a business transaction. In one or more embodiments, the processor communicates the authentication of the user to a financial institution associated with the user, and wherein the financial institution releases payment on behalf of the user based at least in part on the authentication. In one or more embodiments, the financial institution transmits the payment to one or more vendors indicated by the user.

In one or more embodiments, the processor detects an interruption event or transaction event associated with the augmented reality device, and wherein the biometric tracking device captures new biometric data from the user in order to re-authenticate the user based at least in part on the detected event. In one or more embodiments, the interruption of activity is detected based at least in part on a removal of the augmented reality device from the user's head.

In one or more embodiments, the interruption of activity is detected based at least in part on a loss of connectivity of the augmented reality device with a network. In one or more embodiments, the transaction event is detected based at least in part on an express approval of a transaction by the user. In one or more embodiments, the transaction event is detected based at least in part on a heat map associated with the user's gaze. In one or more embodiments, the transaction event is detected based at least in part on user input received through the augmented reality device. In one or more embodiments, the user input comprises an eye gesture. In one or more embodiments, the user input comprises a hand gesture.

In one or more embodiments, the biometric tracking device comprises an eye tracking system. In one or more embodiments, the biometric tracking device comprises a haptic device. In one or more embodiments, the biometric tracking device comprises a sensor that measures physiological data pertaining to a user's eye.

Additional and other objects, features, and advantages of the invention are described in the detail description, figures and claims.

### BRIEF DESCRIPTION OF THE DRAWINGS

The drawings illustrate the design and utility of various embodiments of the present invention. It should be noted that the figures are not necessarily drawn to scale and that elements of similar structures or functions are represented by like reference numerals throughout the figures. In order to better appreciate how to obtain the above-recited and other advantages and objects of various embodiments of the invention, a more detailed description of the present invention briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example augmented reality scene being displayed to a user.

FIG. 2A-2D illustrates various configurations of an example augmented reality device.

FIG. 3 illustrates an augmented reality device communicating with one or more servers in the cloud, according to one embodiment.

4A-4D illustrates various eye and head measurements taken in order to configure the augmented reality device for a particular user.

FIG. 5 shows a plan view of various components of an augmented reality device according to one embodiment.

FIG. 6 shows a system architecture of the augmented reality system for conducting business transactions, according to one embodiment.

FIG. 7 is an example flowchart depicting a method for conducting a business transaction through the augmented reality device.

FIG. 8A and 8B illustrate an example eye-identification method to identify a user, according to one embodiment.

FIG. 9 illustrates an example flowchart depicting a method of using eye-movements to authenticate a user, according to one embodiment.

FIG. 10A-10I illustrates a series of process flow diagrams depicting an example scenario of conducting a business transaction using an augmented reality device.

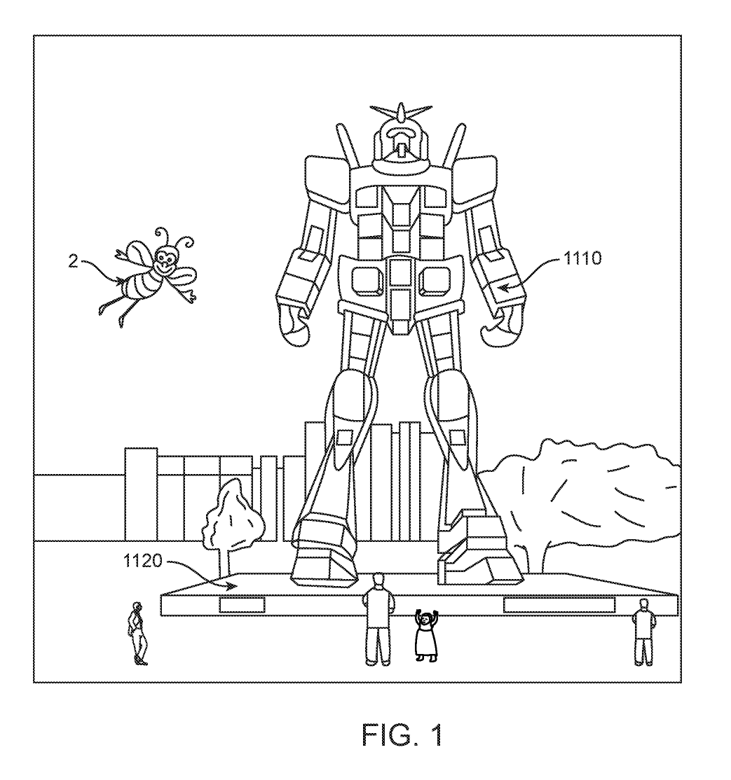

### DETAILED DESCRIPTION

Various embodiments of the invention are directed to methods, systems, and articles of manufacture for implementing multi-scenario physically-aware design of an electronic circuit design in a single embodiment or in multiple embodiments. Other objects, features, and advantages of the invention are described in the detailed description, figures, and claims.

Various embodiments will now be described in detail with reference to the drawings, which are provided as illustrative examples of the invention so as to enable those skilled in the art to practice the invention. Notably, the figures and the examples below are not meant to limit the scope of the present invention. Where certain elements of the present invention may be partially or fully implemented using known components (or methods or processes), only those portions of such known components (or methods or processes) that are necessary for an understanding of the present invention will be described, and the detailed descriptions of other portions of such known components (or methods or processes) will be omitted so as not to obscure the invention. Further, various embodiments encompass present and future known equivalents to the components referred to herein by way of illustration.

Disclosed are methods and systems for tracking biometric data associated with AR users and utilizing the biometric data to assist in business transactions. In one or more embodiments, the AR device may utilize eye identification techniques (e.g., iris patterns, eye vergence, eye motion, patterns of cones and rods, patterns in eye movements, etc.) to authenticate a user for a purchase. Advantageously, this type of user authentication minimizes friction costs in conducting business transactions, and allows the user to make purchases (e.g., brick and mortar stores, online stores, in response to an advertisement, etc.) seamlessly with minimal effort and/or interruption. Although the following disclosure will mainly focus on authentication based on eye-related biometric data, it should be appreciated that other types of biometric data may be similarly used for authentication purposes in other embodiments as well. Various embodiments as will be described below discuss the new paradigm of conducting business in the context of augmented reality (AR) systems, but it should be appreciated that the techniques disclosed here may be used independently of any existing and/or known AR systems. Thus, the examples discussed below are for example purposes only and the invention should not be read to be limited to AR systems.

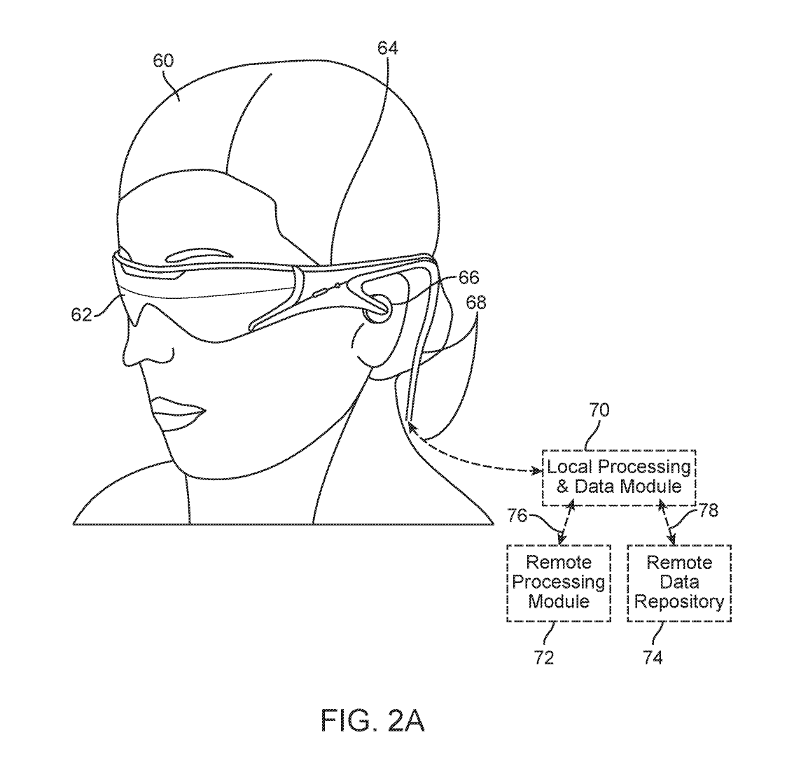

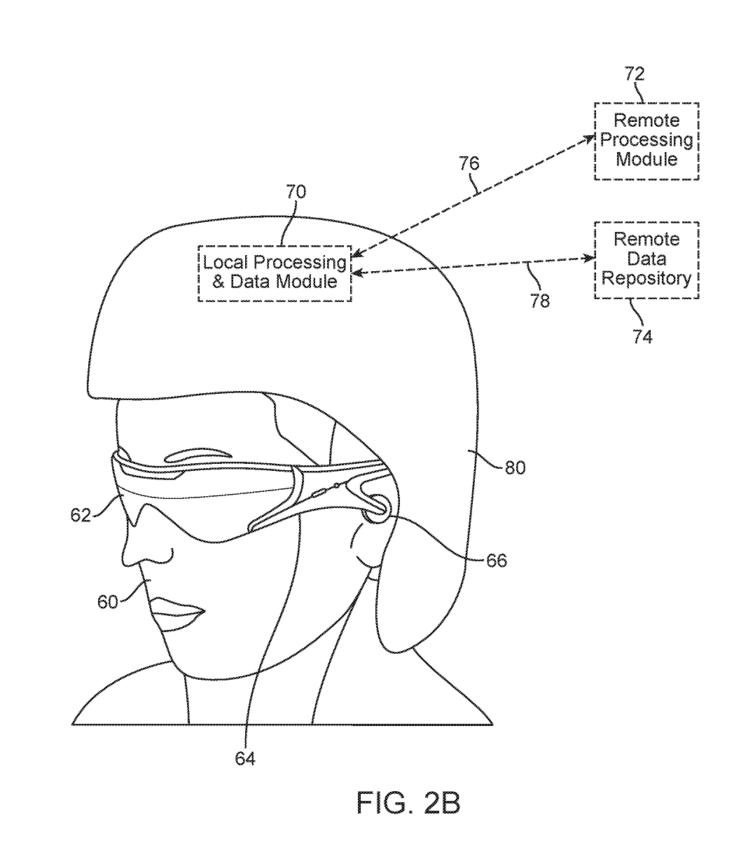

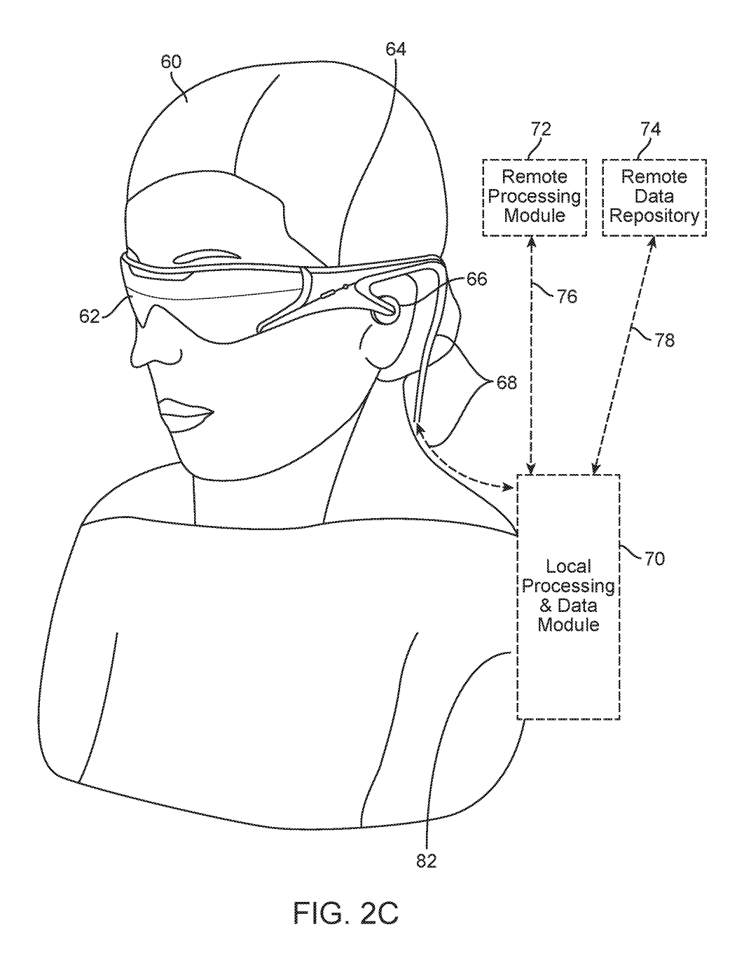

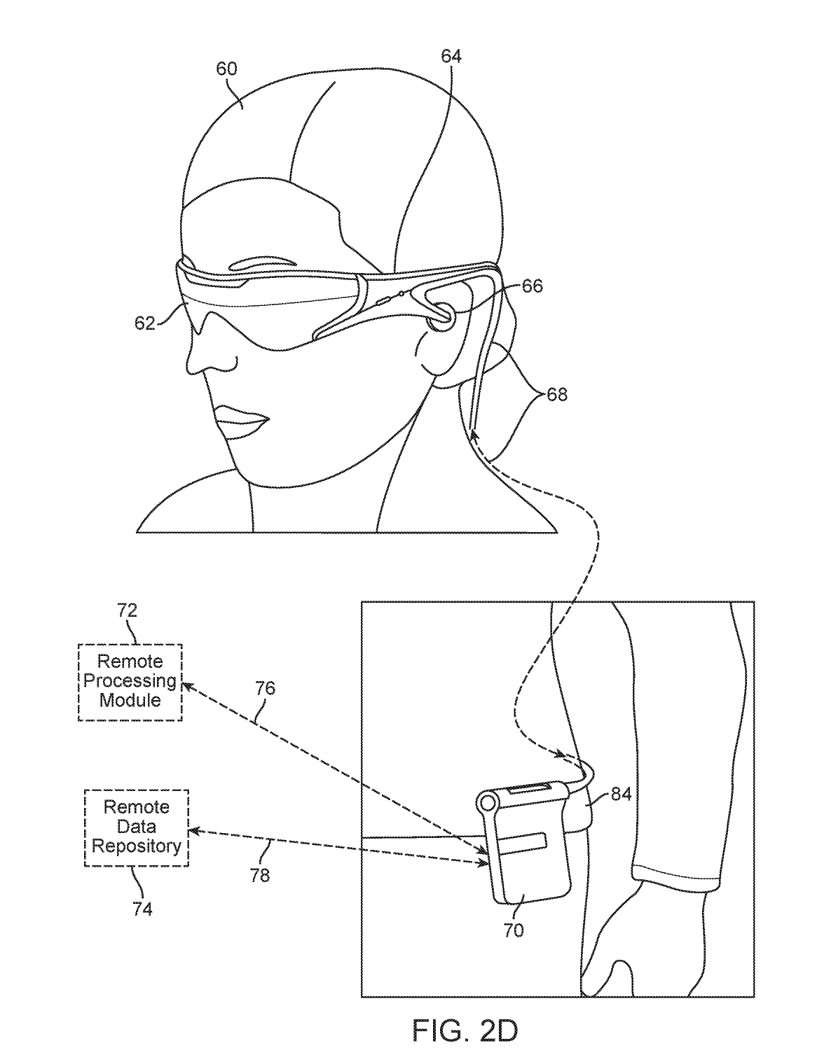

Referring to FIGS. 2A-2D, some general componentry options are illustrated. In the portions of the detailed description which follow the discussion of FIGS. 2A-2D, various systems, subsystems, and components are presented for addressing the objectives of providing a high-quality, comfortably-perceived display system for human VR and/or AR.

As shown in FIG. 2A, an AR system user 60 is depicted wearing a frame 64 structure coupled to an AR display system 62 positioned in front of the eyes of the user. A speaker 66 is coupled to the frame 64 in the depicted configuration and positioned adjacent the ear canal of the user (in one embodiment, another speaker, not shown, is positioned adjacent the other ear canal of the user to provide for stereo/shapeable sound control). The display 62 is operatively coupled 68, such as by a wired lead or wireless connectivity, to a local processing and data module 70 which may be mounted in a variety of configurations, such as fixedly attached to the frame 64, fixedly attached to a helmet or hat 80 as shown in the embodiment of FIG. 2B, embedded in headphones, removably attached to the torso 82 of the user 60 in a backpack-style configuration as shown in the embodiment of FIG. 2C, or removably attached to the hip 84 of the user 60 in a belt-coupling style configuration as shown in the embodiment of FIG. 2D.

The local processing and data module 70 may comprise a power-efficient processor or controller, as well as digital memory, such as flash memory, both of which may be utilized to assist in the processing, caching, and storage of data a) captured from sensors which may be operatively coupled to the frame 64, such as image capture devices (such as cameras), microphones, inertial measurement units, accelerometers, compasses, GPS units, radio devices, and/or gyros; and/or b) acquired and/or processed using the remote processing module 72 and/or remote data repository 74, possibly for passage to the display 62 after such processing or retrieval. The local processing and data module 70 may be operatively coupled (76, 78), such as via a wired or wireless communication links, to the remote processing module 72 and remote data repository 74 such that these remote modules (72, 74) are operatively coupled to each other and available as resources to the local processing and data module 70.

In one embodiment, the remote processing module 72 may comprise one or more relatively powerful processors or controllers configured to analyze and process data and/or image information. In one embodiment, the remote data repository 74 may comprise a relatively large-scale digital data storage facility, which may be available through the Internet or other networking configuration in a “cloud” resource configuration. In one embodiment, all data is stored and all computation is performed in the local processing and data module, allowing fully autonomous use without any remote modules.

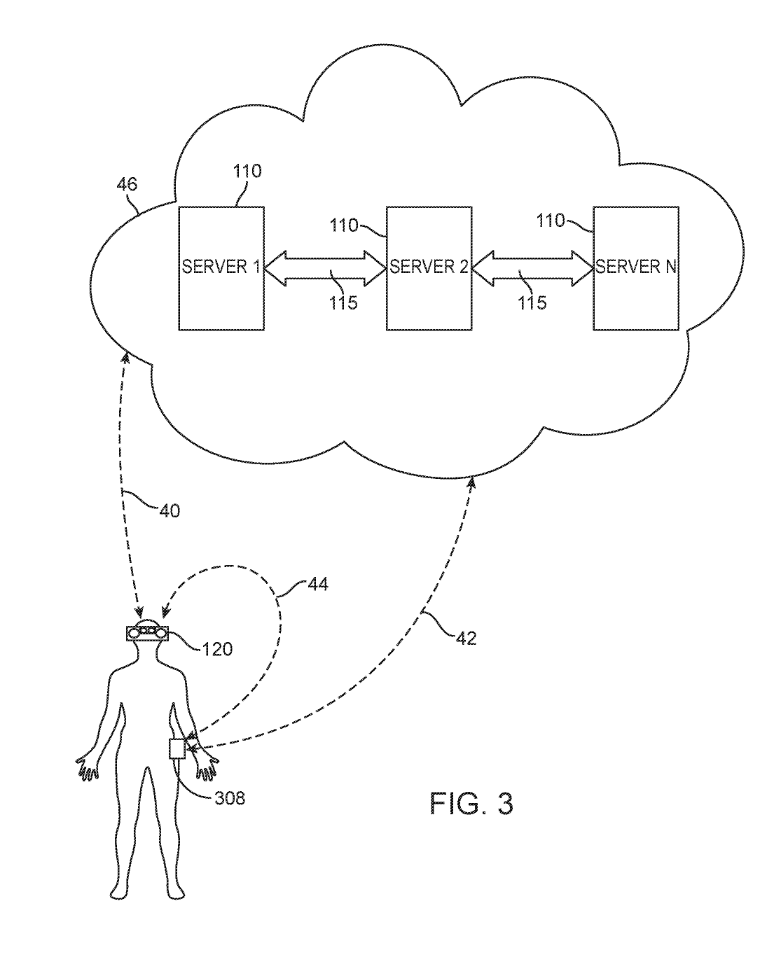

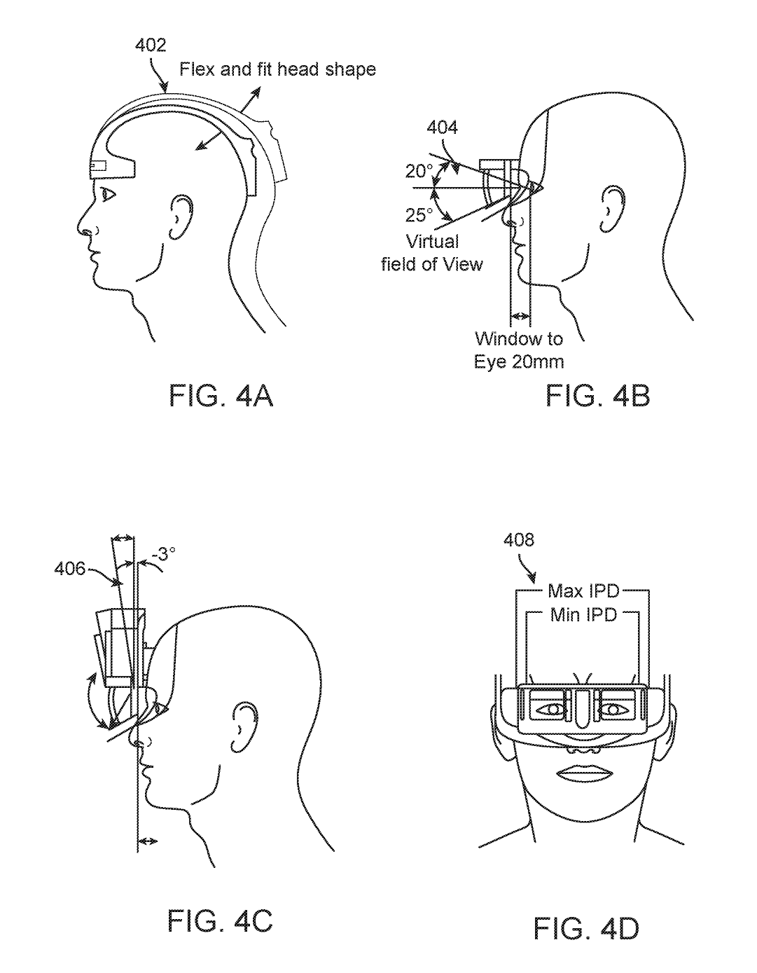

As described with reference to FIGS. 2A-2D, the AR system continually receives input from various devices that collect data about the AR user and the surrounding environment. Referring now to FIG. 3, the various components of an example augmented reality display device will be described. It should be appreciated that other embodiments may have additional components. Nevertheless, FIG. 3 provides a basic idea of the various components, and the types of data that may be collected by AR device.

Referring now to FIG. 3, a schematic illustrates coordination between the cloud computing assets 46 and local processing assets (308, 120). In one embodiment, the cloud 46 assets are operatively coupled, such as via wired or wireless networking (wireless being preferred for mobility, wired being preferred for certain high-bandwidth or high-data-volume transfers that may be desired), directly to (40, 42) one or both of the local computing assets (120, 308), such as processor and memory configurations which may be housed in a structure configured to be coupled to a user's head mounted device 120 or belt 308. These computing assets local to the user may be operatively coupled to each other as well, via wired and/or wireless connectivity configurations 44. In one embodiment, to maintain a low-inertia and small-size head mounted subsystem 120, primary transfer between the user and the cloud 46 may be via the link between the belt-based subsystem 308 and the cloud, with the head mounted subsystem 120 primarily data-tethered to the belt-based subsystem 308 using wireless connectivity, such as ultra-wideband (“UWB”) connectivity, as is currently employed, for example, in personal computing peripheral connectivity applications. Through the cloud 46, the AR display system 120 may interact with one or more AR servers 110 hosted in the cloud. The various AR servers 110 may have communication links 115 that allows the servers 110 to communicate with one another.

With efficient local and remote processing coordination, and an appropriate display device for a user, such as a user interface or user “display device”, or variations thereof, aspects of one world pertinent to a user's current actual or virtual location may be transferred or “passed” to the user and updated in an efficient fashion. In other words, a map of the world is continually updated at a storage location which may partially reside on the user's AR system and partially reside in the cloud resources. The map (also referred to as a passable world model) may be a large database comprising raster imagery, 3D and 2D points, parametric information and other information about the real world. As more and more AR users continually capture information about their real environment (e.g., through cameras, sensors, IMUs, etc.), the map becomes more and more accurate.

More pertinent to the current disclosures, AR systems similar to those described in FIGS. 2A-2D provide unique access to a user's eyes, which may be advantageously used to uniquely identify the user based on a set of biometric data tracked through the AR system. This unprecedented access to the user's eyes naturally lends itself to various applications. Given that the AR device interacts crucially with the user's eye to allow the user to perceive 3D virtual content, and in many embodiments, tracks various biometrics related to the user's eyes (e.g., eye vergence, eye motion, cones and rods, patterns of eye movements, etc.), the resultant tracked data may be advantageously used in user identification and authentication for various transactions, as will be described in further detail below.

The AR device is typically fitted for a particular user's head, and the optical components are aligned to the user's eyes. These configuration steps may be used in order to ensure that the user is provided with an optimum augmented reality experience without causing any physiological side-effects, such as headaches, nausea, discomfort, etc. Thus, in one or more embodiments, the AR device is configured (both physically and digitally) for each individual user, and may be calibrated specifically for the user. In other scenarios, a loose fitting AR device may be used comfortably by a variety of users. For example, in some embodiments, the AR device knows the distance between the user's eyes, the distance from the head worn display and the user's eyes, a distance between the user's eyes, a curvature of the user's forehead. All of these measurements may be used to provide the appropriate head-worn display system for a given user. In other embodiments, such measurements may not be necessary in order to perform the identification and authentication function described in this application.

For example, referring to FIG. 4A-4D, the AR device may be customized for each user. The user's head shape 402 may be taken into account when fitting the head-mounted AR system, in one or more embodiments, as shown in FIG. 4A. Similarly, the eye components 404 (e.g., optics, structure for the optics, etc.) may be rotated or adjusted for the user's comfort both horizontally and vertically, or rotated for the user's comfort, as shown in FIG. 4B. In one or more embodiments, as shown FIG. 4C, a rotation point 406 of the head set with respect to the user's head may be adjusted based on the structure of the user's head. Similarly, the inter-pupillary distance (IPD) 408 (i.e., the distance between the user's eyes) may be compensated for, as shown in FIG. 4D.

Advantageously, in the context of user identification and authentication, this aspect of the head-worn AR devices is crucial because the system already possesses a set of measurements about the user's physical features (e.g., eye size, head size, distance between eyes, etc.), and other data that may be used to easily identify the user, and allow the user to complete one or more business transactions. Additionally, the AR system may easily be able to detect when the AR system is being worn by a different AR user other than a user that is authorized to the use the AR system. This allows the AR system to constantly monitor the user's eyes, and thus be aware of the user's identity as needed.

In addition to the various measurements and calibrations performed on the user, the AR device may be configured to track a set of biometric data about the user. For example, the system may track eye movements, eye movement patterns, blinking patterns, eye vergence, eye color, iris patterns, retinal patters, fatigue parameters, changes in eye color, changes in focal distance, and many other parameters, that may be used in providing an optical augmented reality experience to the user.

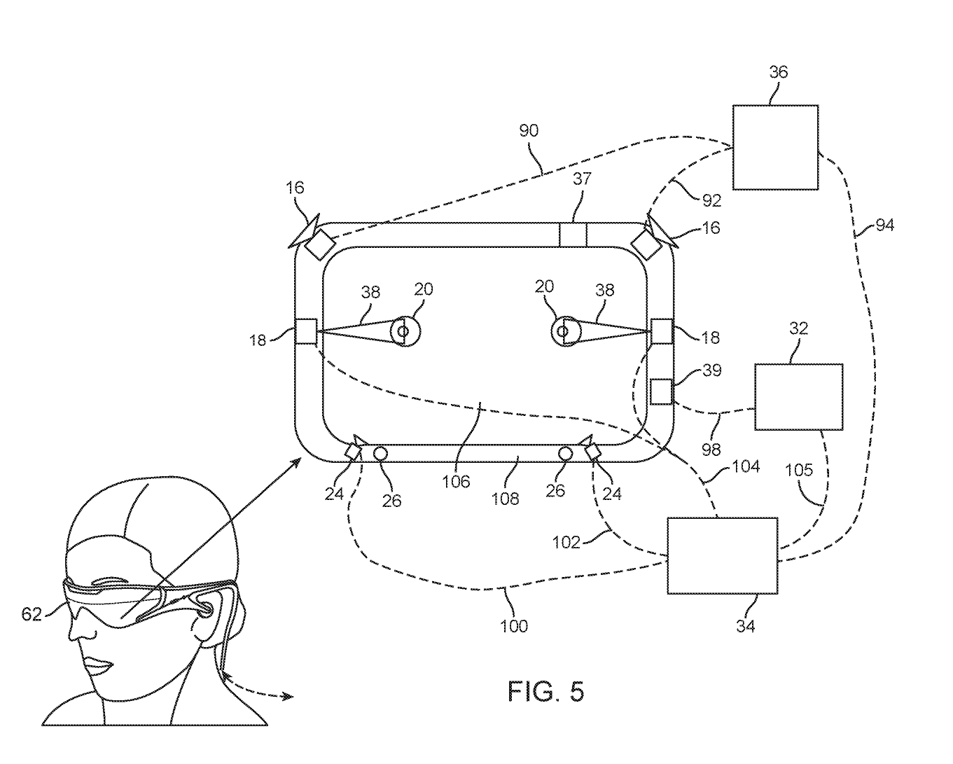

Referring to FIG. 5, one simplified embodiment of a suitable user display device 62 is shown, comprising a display lens 106 which may be mounted to a user's head or eyes by a housing or frame 108. The display lens 106 may comprise one or more transparent mirrors positioned by the housing 108 in front of the user's eyes 20 and configured to bounce projected light 38 into the eyes 20 and facilitate beam shaping, while also allowing for transmission of at least some light from the local environment. In the depicted embodiment, two wide-field-of-view machine vision cameras 16 are coupled to the housing 108 to image the environment around the user; in one embodiment these cameras 16 are dual capture visible light/infrared light cameras.

The depicted embodiment also comprises a pair of scanned-laser shaped-wavefront (i.e., for depth) light projector modules 18 (e.g., spatial light modulators such as DLP, fiber scanning devices (FSDs), LCDs, etc.) with display mirrors and optics configured to project light 38 into the eyes 20 as shown. The depicted embodiment also comprises two miniature infrared cameras 24 paired with infrared light sources 26, such as light emitting diodes “LED”s, which are configured to be able to track the eyes 20 of the user to support rendering and user input. The display system 62 further features a sensor assembly 39, which may comprise X, Y, and Z axis accelerometer capability as well as a magnetic compass and X, Y, and Z axis gyro capability, preferably providing data at a relatively high frequency, such as 200 Hz. The depicted system 62 also comprises a head pose processor 36, such as an ASIC (application specific integrated circuit), FPGA (field programmable gate array), and/or ARM processor (advanced reduced-instruction-set machine), which may be configured to calculate real or near-real time user head pose from wide field of view image information output from the cameras 16. The head pose processor 36 is operatively coupled (90, 92, 94; e.g., via wired or wireless connectivity) to the cameras 16 and the rendering engine 34.

Also shown is another processor 32 configured to execute digital and/or analog processing to derive pose from the gyro, compass, and/or accelerometer data from the sensor assembly 39. The depicted embodiment also features a GPS 37 subsystem to assist with pose and positioning.

Finally, the depicted embodiment comprises a rendering engine 34 which may feature hardware running a software program configured to provide rendering information local to the user to facilitate operation of the scanners and imaging into the eyes of the user, for the user's view of the world. The rendering engine 34 is operatively coupled (105, 94, 100/102, 104; i.e., via wired or wireless connectivity) to the sensor pose processor 32, the image pose processor 36, the eye tracking cameras 24, and the projecting subsystem 18 such that rendered light 38 is projected using a scanned laser arrangement 18 in a manner similar to a retinal scanning display. The wavefront of the projected light beam 38 may be bent or focused to coincide with a desired focal distance of the projected light 38.

The mini infrared cameras 24 may be utilized to track the eyes to support rendering and user input (i.e., where the user is looking, what depth he is focusing; as discussed below, eye vergence may be utilized to estimate depth of focus). The GPS 37, gyros, compass, and accelerometers 39 may be utilized to provide coarse and/or fast pose estimates. The camera 16 images and pose data, in conjunction with data from an associated cloud computing resource, may be utilized to map the local world and share user views with a virtual or augmented reality community.

While much of the hardware in the display system 62 featured in FIG. 5 is depicted directly coupled to the housing 108 which is adjacent the display 106 and the eyes 20 of the user, the hardware components depicted may be mounted to or housed within other components, such as a belt-mounted component 70, as shown, for example, in FIG. 2D.

In one embodiment, all of the components of the system 62 featured in FIG. 5 are directly coupled to the display housing 108 except for the image pose processor 36, sensor pose processor 32, and rendering engine 34, and communication between the latter three and the remaining components of the system may be by wireless communication, such as ultra wideband, or wired communication. The depicted housing 108 preferably is head-mounted and wearable by the user. It may also feature speakers, such as those which may be inserted into the ears of a user and utilized to provide sound to the user.

Having described the principle components of a standard AR device, it should be appreciated that the AR device may comprise many components that are configured to collect data from the user and his/her surroundings. For example, as described above, some embodiments of the AR device collect GPS information to determine a location of the user. In other embodiments, the AR device comprises infrared cameras to track the eyes of the user. In yet other embodiments, the AR device may comprise field-of-view cameras to capture images of the user's environment, which may, in turn, be used to construct a map (contained in one of the servers 110, as described in FIG. 3) of the user's physical space, which allows the system to render virtual content in relation to appropriate real-life objects, as described briefly with respect to FIG. 3.

Regarding the projection of light 38 into the eyes 20 of the user, in one embodiment the mini cameras 24 may be utilized to measure where the centers of a user's eyes 20 are geometrically verged to, which, in general, coincides with a position of focus, or “depth of focus”, of the eyes 20. A three dimensional surface of all points the eyes verge to is called the “horopter”. The focal distance may take on a finite number of depths, or may be infinitely varying. Light projected from the vergence distance appears to be focused to the subject eye 20, while light in front of or behind the vergence distance is blurred.

Further, it has been discovered that spatially coherent light with a beam diameter of less than about 0.7 millimeters is correctly resolved by the human eye regardless of where the eye focuses; given this understanding, to create an illusion of proper focal depth, the eye vergence may be tracked with the mini cameras 24, and the rendering engine 34 and projection subsystem 18 may be utilized to render all objects on or close to the horopter in focus, and all other objects at varying degrees of defocus (i.e., using intentionally-created blurring). A see-through light guide optical element configured to project coherent light into the eye may be provided by suppliers such as Lumus, Inc. Preferably the system 62 renders to the user at a frame rate of about 60 frames per second or greater. As described above, preferably the mini cameras 24 may be utilized for eye tracking, and software may be configured to pick up not only vergence geometry but also focus location cues to serve as user inputs. Preferably such a system is configured with brightness and contrast suitable for day or night use.

In one embodiment such a system preferably has latency of less than about 20 milliseconds for visual object alignment, less than about 0.1 degree of angular alignment, and about 1 arc minute of resolution, which is approximately the limit of the human eye. The display system 62 may be integrated with a localization system, which may involve GPS elements, optical tracking, compass, accelerometers, and/or other data sources, to assist with position and pose determination; localization information may be utilized to facilitate accurate rendering in the user's view of the pertinent world (i.e., such information would facilitate the glasses to know where they are with respect to the real world). Having described the general components of the AR device, additional embodiments specifically pertinent to user identification and authentication for conducting business transactions will be discussed below.

As discussed in some detail above, the traditional model(s) for conducting business transactions tend to be inefficient and onerous, and often have the effect of deterring users from engaging in transactions. For example, consider a user at a department store. In traditional models, the user is required to physically go to a store, select items, stand in line, wait for the cashier, provide payment information and or identification, and authorize payment. Even online shopping, which is arguably less cumbersome, comes with its share of drawbacks. Although the user does not have to physically be at the store location and can easily select items of interest, payment still often requires credit card information and authentication. With the advent of AR devices, however, the traditional models of payment (e.g., cash, credit card, monetary tokens, etc.) may be rendered unnecessary, because the AR device can easily confirm the user's identity and authenticate a business transaction.

For example, an AR user may leisurely stroll into a retail store and pick up an item. The AR device may confirm the user's identity, confirm whether the user wants to make the purchase, and simply walk out of the store. In one or more embodiments, the AR device may interface with a financial institution that will transfer money from the user's account to an account associated with the retail store based on the confirmed purchase. Or, in another example, the AR user may watch an advertisement for a particular brand of shoes. The user may indicate, through the AR device, that the user wants to purchase the shoes. The AR device may confirm identity of the user, and authenticate the purchase. On the back-end, an order may be placed at the retailer of the brand of shoes, and the retailer may simply ship a pair of the desired shoes to the user. As illustrated by the above examples, since the AR device “knows” the identity of the user (and AR devices are typically built and customized for every individual user), financial transactions are easily authenticated, thereby greatly reducing the friction costs typically associated with conducting business.

More particularly, in one or more embodiments, the AR device may periodically perform an identification test of the user for privacy and security purposes. As discussed in some detail above, although the AR device is typically customized for each user, this periodic identification and authentication of the user is necessary for security purposes especially in the context of conducting business transactions, or for privacy purposes to ensure that the AR device is not being used by unknown users and being linked to the AR user's account on the cloud. This application describes systems and methods for ensuring security for financial/business transactions in which case user identification and authentication is paramount. Similarly, these steps are equally important to ensure user privacy. In fact, these identification steps may be used prior to opening any personal/private user account (e.g., email, social network, financial account, etc.) through the AR device.

Other embodiments described in this application may be used in the context of anti-theft management. For example, the AR device may identify the user to ensure that the AR device hasn't been stolen. If the AR device detects an unknown user, the AR device may immediately send captured information about the user, and the location of the AR device to the AR server. Or, in other embodiments, if it is detected that the AR device is being used by someone who is not identified, the AR device may shut down entirely and automatically delete all contents in the memory of the AR device such that no confidential information is leaked or misused. These security measures may prevent thefts of the AR device, because the AR device is able to capture many types of information about a wearer of the AR device.

In one or more embodiments the embodiments described below may enable an AR device to tele-operate a shopping robot. For example, once a user of the AR device has been identified, the AR device may connect to a shopping robot through a network of a particular store or franchise, and communicate a transaction with the shopping robot. Thus, even if the user is not physically in the store the AR device may conduct transactions through a proxy, once the user has been authenticated. Similarly, many other security and/or privacy applications may be envisioned.

There are many methods of performing identification through tracked biometric data. In one embodiment, the tracked biometric data may be eye-related biometric data such as patterns in eye movements, iris patterns, eye vergence information, etc. In essence, rather than requiring the user to remember a password, or present some type of identification/verification, the AR device automatically verifies identity through the use of the tracked biometric data. Given that the AR device has constant access to the user's eyes, it is anticipated that the tracked data will provide highly accurate and individualized information about the identity of the user, which may be thought of as a unique user signature. Before exploring details on different ways of tracking biometric data, and using the tracked biometric data to authenticate the user, a system architecture of the AR device interacting with one or more outside entities (e.g., financial institutions, vendors, etc.) will be provided.

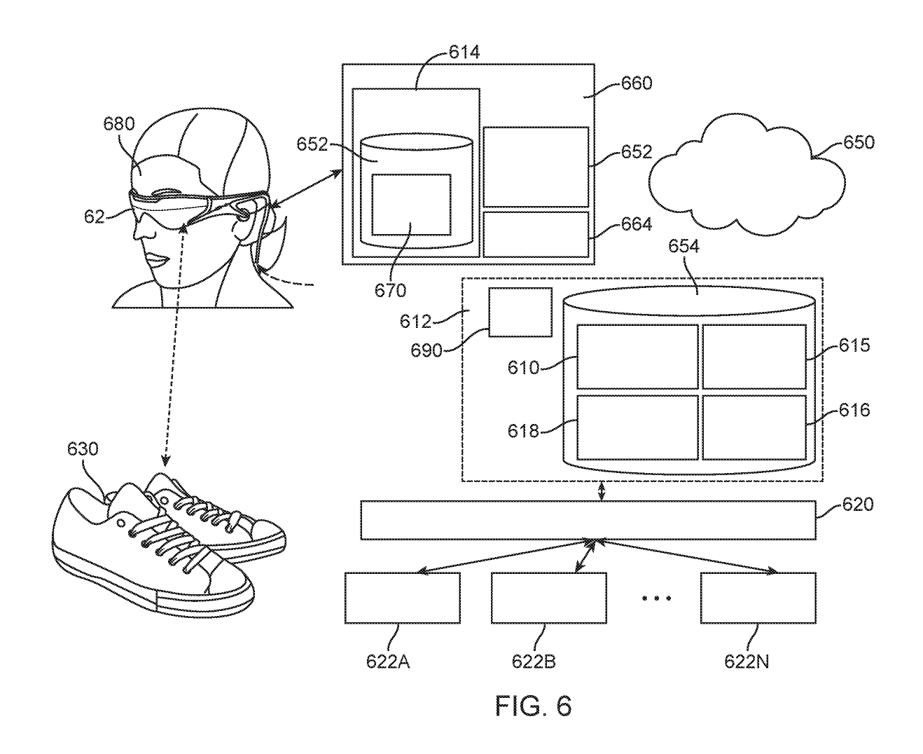

Referring now to FIG. 6, an overall AR system architecture is illustrated. The AR system architecture comprises a head-worn AR device 62, a local processing module 660 of the AR device 62, a network 650, an AR server 612, a financial institution 620 and one or more vendors (622A, 622B, etc.).

As discussed above (refer to FIG. 5), the head-worn AR device 62 comprises many sub-components, some of which are configured to capture and/or track information associated with the user and/or surroundings of the user. More particularly, in one or more embodiments, the head-worn AR device 62 may comprise one or more eye tracking cameras. The eye tracking cameras may track the user's eye movements, eye vergence, etc. In another embodiment, the eye tracking cameras may be configured to capture a picture of the user's iris. In other embodiments, the head-worn AR device 62 may comprise other cameras configured to capture other biometric information. For example, associated cameras may be configured to capture an image of the user's eye shape. Or, in another example, cameras (or other tracking devices) may capture data regarding the user's eye lashes. The tracked biometric information (e.g., eye data, eye-lash data, eye-shape data, eye movement data, head data, sensor data, voice data, fingerprint data, etc.) may be transmitted to the local processing module 660. As shown in FIG. 2D, in one or more embodiments, the local processing module 660 may be part of a belt pack of the AR device 62. Or, in other embodiments the local processing module may be part of the housing of the head-worn AR device 62.

As shown in FIG. 6, the head-worn AR device 62 of a user 680 interfaces with the local processing module 660 to provide the captured data. In one or more embodiments, the local processing module 660 comprises a processor 664 and other components 652 (e.g., memory, power source, telemetry circuitry, etc.) that enable the AR system to perform a variety of computing tasks. Significant to the current disclosure, the local processing module 660 may also comprise an identification module 614 to identify a user based on information tracked by the one or more tracking devices of the head-worn AR device 62.

In one or more embodiments, the identification module 614 comprises a database 652 to store a set of data with which to identify and/or authenticate a user. For example, in the illustrated embodiment, the database 652 comprises a mapping table 670 that may store a set of predetermined data and/or predetermined authentication details or patterns. In one or more embodiments, the captured data may be compared against the predetermined data stored at the mapping table 670 to determine the identity of the user 680. Similarly, the database 652 may comprise other data to be used in performing the identification/authentication of the user 680. In one or more embodiments, the database 652 may store one or more eye tests to verify the identity of the user, as will be described in detail further below.

In one or more embodiments, the local processing module 660 communicates with an AR server 612 through a cloud network 650. Although not illustrated in FIG. 6, the AR server 612 comprises many components/circuitry that are crucial to providing a realistic augmented reality experience to the user 680. Briefly, the AR server 612 comprises a map 690 of the physical world that is frequently consulted by the local processing module 660 of the AR device 62 to render virtual content in relation to physical objects of the real world. Thus, the AR server 612 builds upon information captured through numerous users to build an ever-growing map 690 of the real world. In other embodiments, the AR server 612 may simply host the map 690 which may be built and maintained by a third party.

In one or more embodiments, the AR server 612 may also host an individual user's account, where the user's private captured data is channeled. This captured data may be stored in a database 654, in one or more embodiments. In one or more embodiments, the database 654 may store user information 610, historical data 615 about the user 680, user preferences 616 and other entity authentication information 618. Indeed, other embodiments of the AR system may comprise many other types of information individual to the user. The user information 610 may comprise a set of personal biographical information (e.g., name, age, gender, address, location, etc.), in one or more embodiments.

Historical data 615 about the user 680 may refer to previous purchases and/or transactions performed by the user. In one or more embodiments, user preferences 616 may comprise a set of interests (e.g., shopping, activities, travel, etc.) and/or purchasing preferences (e.g., accessories, brands of interest, shopping categories, etc.) about the user. In one or more embodiments, behavioral data of the AR user may be used to inform the system of the user's preferences and/or purchasing patterns. Other entity authentication information 618 may refer to authentication credentials of the user to verify that the user has been successfully authenticated to access outside accounts (e.g., banking authentication information, account authentication information of various websites, etc.)

In one or more embodiments, the data captured through the AR device 62, data tracked through past activity, business data associated with the user, etc. may be analyzed to recognize patterns and/or to understand a behavior of the user. These functions may be performed by a third party, in one or more embodiments, in a privacy and security-sensitive manner.

The database 654 may also store other entity authentication information 618 that allows the AR server 612 to communicate with financial institutions and/or third party entities particular to the user. For example, the other entity authentication information 618 may refer to the user's banking information (e.g., bank name, account information, etc.). This information may, in turn, be used to communicate with financial information, third party entities, vendors, etc.

In one or more embodiments, the AR server 612 may communicate with one or more financial institutions 620 in order to complete transactions. The financial institution may have the user's financial information. In one or more embodiments, the financial institution may perform a second verification of the user's authentication information for security purposes. Once the user is authenticated, the AR server 612 may be authenticated to communicate with the financial institution 620. If the user is authenticated for a particular purchase of an item 630, the financial institution 620 may directly communicate with one or more vendors (622A, 622B, etc.) to directly transmit money to the vendors once the user has been authenticated. In other embodiments (not shown), the AR server 612 may communicate directly with the vendors as well to communicate data regarding one or more purchases.

It should be appreciated that in some embodiments, the user 680 may not need to connect to the AR server 612 to proceed with one or more financial transactions. For example, in some embodiments, the AR device 62 may allow “offline browsing” of a plurality of e-commerce sites, etc., and the user 680 may be able to select one or more items of interest through an offline ID. The financial institution 620 or vendor 622 may have a random number generator created for that particular transaction, which may be later verified once the AR device 62 is connected to the network 650. In other words, even if the AR device 62 does not connect to the AR server, the system may validate the transaction offline, and then use additional information (e.g., random generated number) to verify the purchase at a later time. This allows the AR device 62 to participate in necessary commercial transactions even if the user is not currently connected to the AR server 612 and/or financial institutions or vendors.

In one or more embodiments, the vendors (622A, 622B, etc.) may have a pre-established relationship with the AR server 612 and/or the financial institution(s) 620 that enables this new paradigm of making purchases through the AR device 62. It should be appreciated that the embodiments described above are provided for illustrative purposes only, and other embodiments may comprise greater or fewer components.

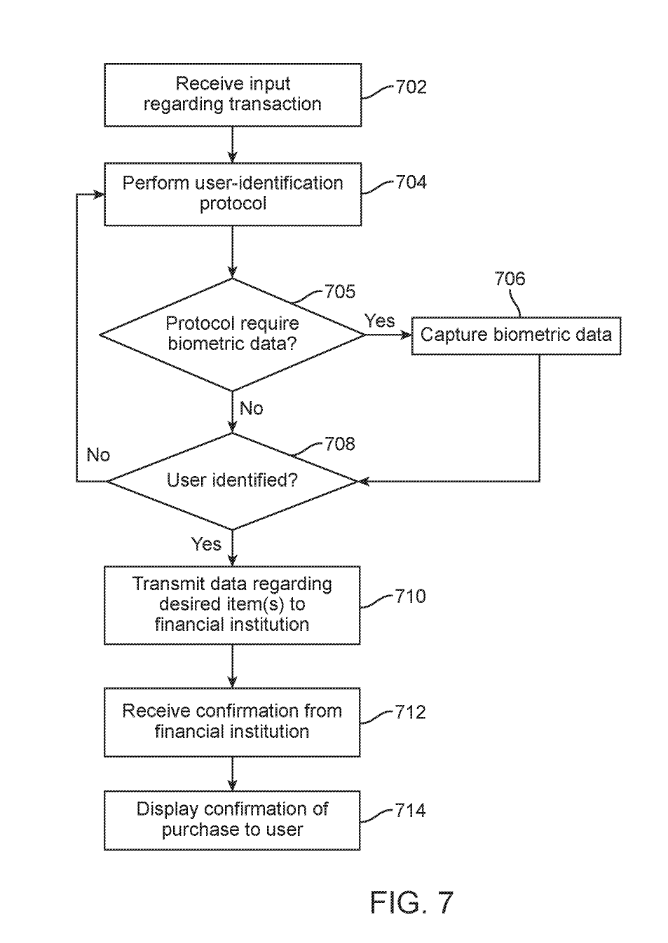

Referring now to FIG. 7, an example flowchart of conducting a business transaction through the AR device 62 is provided. At 702, an input may be received regarding a transaction. For example, the user may explicitly indicate (e.g., through a command, a gesture, etc.) an interest in purchasing an item. In other embodiments, the AR system, may suggest a purchase to the AR user based on past purchases, user interests, etc., and receive a confirmation from the user. In yet other embodiments, the AR system may assess interest based on “heat maps” of various items. To elaborate, because the AR device 62 knows where the user is looking, and for how long, the AR device 62 may be able to determine how long a user has looked at various virtual and/or real objects, in order to determine the user's interest in an item. For example, if the user is viewing a virtual advertisement for a particular brand, the AR device 62 may gauge the user's interest by determining how long the user has looked at a particular product. In one or more embodiments, the AR system may generate heat maps based on how long one or more users have looked at a particular product. If the heat map indicates interest in a particular product (e.g., amount of time spent looking at a particular item exceeds a predetermined threshold amount of time), the AR device 62 may request confirmation from the AR user about purchase of the product.

At 704, the AR device 62 may perform a user-identification protocol. There may be many types of user-identification protocols, as will be described in further detail below. In one or more embodiments, the AR device 62 may request a “password” based simply on eye movements to determine if the user is verified. In another embodiment, the AR device 62 may capture a picture of the user's iris, and confirm whether the user is the valid user of the AR device 62 (and the accounts linked to the AR device 62). In another embodiment, the AR device 62 may monitor a continuity of the AR device 62 remaining on the user's head (e.g., if the user has not removed the AR device 62 at all, it is likely that the user is the same). In one or more embodiments, the AR device 62 may, based on the user-identification protocol, periodically capture iris images, or periodically perform tests to ensure that the user is the verified user of the AR device 62. As discussed here, there are many ways to identify the user through biometric data, and some example methods will be described further below.

In some embodiments, the identification protocol may be a constant identification (e.g., movement patterns of the eye, contact with skin, etc.) of the user. In other embodiments, the identification protocol may simply be a one-time identification (through any identification method). Thus, in some embodiments, once the AR system has identified a user once, the same user may not need to be identified unless an intervening event occurs (e.g., user removes AR device 62, interruption in network connectivity, etc.). At 705, the AR device 62 may determine whether the identification protocol requires capture of biometric data. If the user protocol requires biometric data to be captured, the AR device may capture biometric data. Otherwise, the AR device 62 may proceed to identify the user through a non-biometric capture identification method.

At 706, based on the user-identification protocol, biometric data may be captured. For example, if the user-identification protocol is an eye test to detect a known pattern, the AR device 62 may track the user's eye movement through one or more eye tracking cameras. The captured movement may be correlated with the “password” or signature eye movement to determine if the user is verified. Or, if the user-identification protocol is iris capture, an image of the iris may be captured, and be correlated with the known image of the user. Or, every time an AR user wears the AR device 62, an iris capture or an eye test may be performed to verify the identity of the user. It should be appreciated that the biometric data may be eye-related in some embodiments, or may be other types of biometric data. For example, the biometric data may be voice, in one or more embodiments. In one or more embodiments, the biometric data may be eye lash related data, or eye shape data. Any type of biometric data that may be used to uniquely identify a user over other users may be used.

At 708, the biometric data may be compared to predetermined user identification data, to identify the user. Or, if the user identification doesn't require biometric data, the AR device 62 may determine, for example, that the user has not taken off the AR device 62, therefore indicating that the user is the same as the previously identified user. If the user is identified, the AR device 62 proceeds to 710 and transmits information to one or more financial institutions.

If the user is not identified, the AR device 62 may perform another user-identification protocol, or else block the user from making the transaction. If the user is identified, data regarding the desired item may be transmitted to the cloud, and to the financial institution, at 710. For example, following the example above, information about the desired shoes (e.g., product number, quantity desired, information about the user, shipping address, user account, etc.) may be communication to the vendors and/or financial institution.

At 712, the AR system may receive confirmation from the financial institution that payment is complete and/or authorized. At 714, a confirmation message may be displayed to the user to confirm that the purchase has been complete.

As discussed above, in one or more embodiments, one approach to identify a user for validation purposes (for financial transactions and other purposes) is by periodically administering a user identification test. In one or more embodiments, the user-identification method may utilize eye-related data to complete the user identification test. Because the AR device 62 is equipped with eye tracking cameras that continually track the user's eye movements, a known pattern of eye movements may be used as an eye test to recognize and/or identify a user. For example, while a password may be easily copied or stolen, it may be difficult to replicate eye movements or other physiological characteristics of other users, making it easier to identify non-authorized users of the AR device 62.

In one or more embodiments, during set-up of the AR device 62, the system may, with input of the user, configure a known pattern of eye movement (i.e., akin to an eye-password) unique to the user. This known pattern of eye movement may be stored and correlated every time the user-identification protocol is performed.

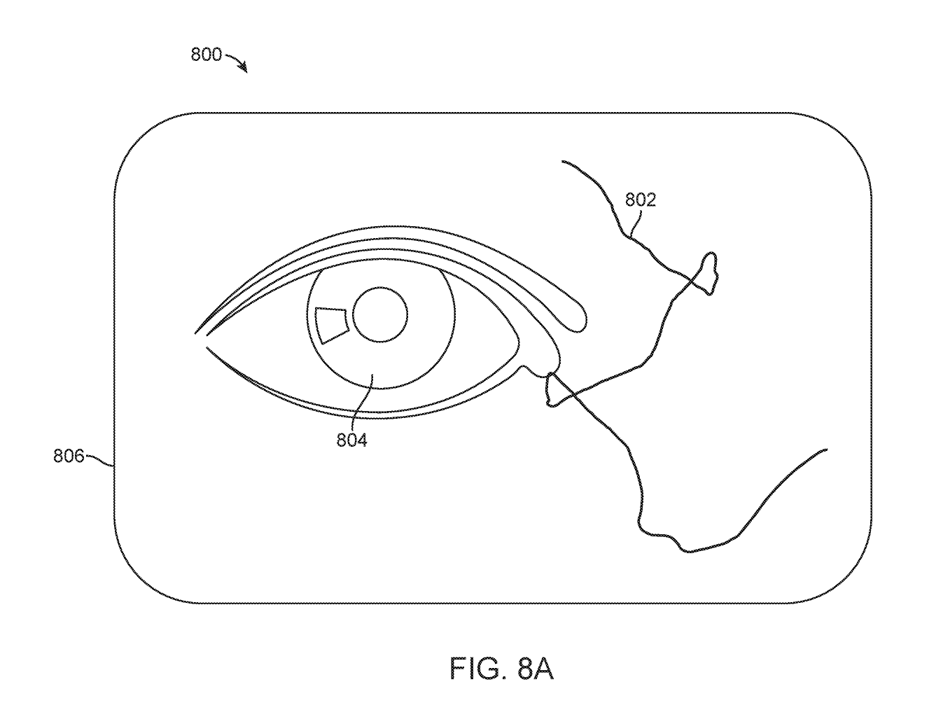

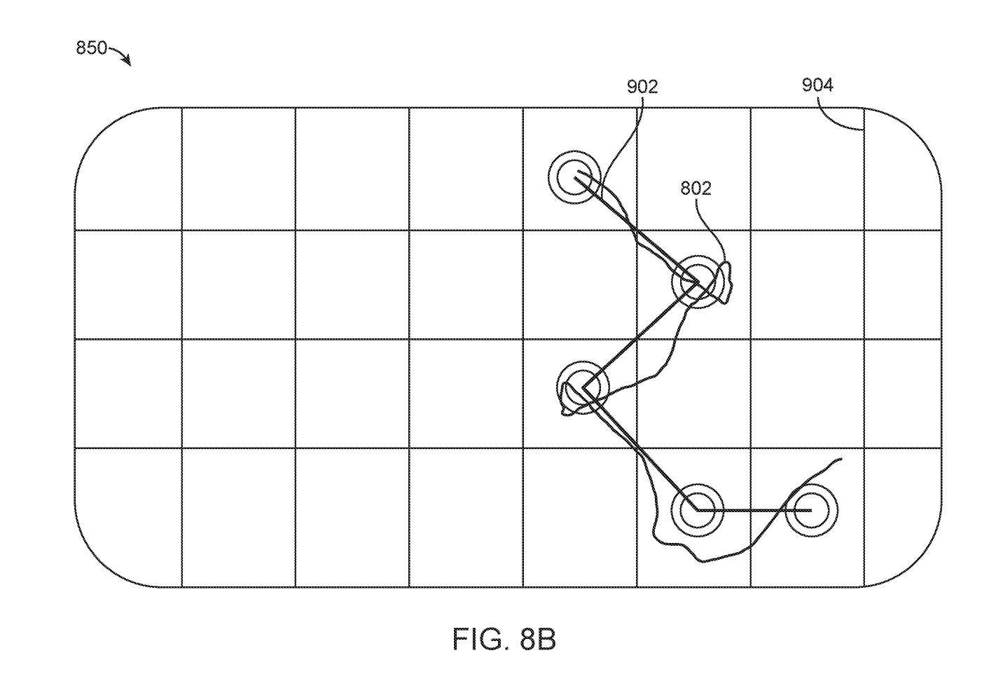

Referring now to the embodiment 800 of FIG. 8A and 8B, an example eye pattern 802 of a user's eyes 804 is provided. As shown in FIG. 8A, the AR device 806 may track the user's eye movement through eye-tracking cameras (not shown), and correlate the pattern with the known pattern of the eye movement (i.e., eye password). If the eye movement pattern is close to the known pattern (within a threshold), the AR device 806 may allow the user to conduct the transaction. As shown in FIG. 8A, the user may have moved his/her eye in the denoted pattern. For illustrative purposes, a line (802) is drawn to represent the eye pattern. Of course, in practice, there would be no line, but the eye tracking devices would simply track such a movement and convert it to a desired data format.

In one or more embodiments, to determine whether the tracked eye pattern correlated with the predetermined known pattern of eye movement, a grid 904 similar to that shown in FIG. 8B may be utilized. It should be appreciated that other such techniques may be used as well. By dividing an available space into discretized areas, through use of the grid 904, it may be easier to determine whether the tracked eye pattern 802 resembles the predetermined pattern 902 most closely. For example, as shown in FIG. 8B, the tracked eye pattern 802 more or less follows the predetermined pattern 902 (as denoted by the bold line connecting the centers of each grid square associated with the predetermined pattern). Although FIG. 8B represents a rather simplified version of the grid 904, it should be appreciated that the size of each grid may be reduced for more accurate determinations.

In the illustrated embodiment, if the tracked eye movement covers an area of the predetermined grid square, the pattern may be recognized. In other embodiments, a majority of the grid squares may need to be hit before the user is deemed to have passed the user-identification test. Similarly, other such thresholds may be devised for various eye-movement tracking protocols. In one or more embodiments, similar to the above, a blink pattern may be similarly utilized. For example, rather than utilizing an eye movement pattern, the eye-password may be a series of blinks, or blinks combined with movement to track a signature of the user.

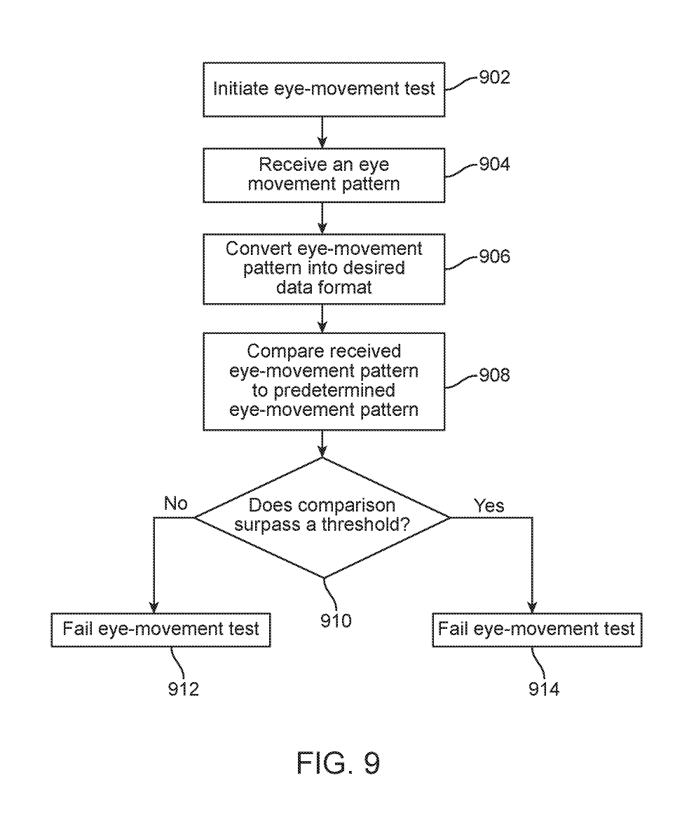

Referring now to FIG. 9, an example process of detecting an eye-movement signature is described. At 902, an eye-movement test may be initiated. For example, the AR user may indicate a desire to purchase an item, or the AR user may have put down the AR device 62, 806 and may resume wearing the AR device 62, 806. In another embodiment, the eye-movement test may be administered periodically for security purposes.

At 904, an eye-movement pattern may be tracked and received. For example, a virtual display screen may display instructions to “enter password,” which may trigger the user to form the known pattern with his/her eyes.

At 906, the tracked eye-movement may be converted into a particular data format. For example, referring back to the grid approach, the data may indicate the coordinates of the grids that were hit by the eye-movement. Many other approaches may be similarly used.

At 908, the converted data may be compared to a predetermined data of a known signature eye-movement pattern. At 910, the AR system may determine if the tracked eye-movement matches the predetermined pattern within a threshold. At 912, if it is determined that the eye pattern does not match the known eye pattern within a threshold, the user fails the test, and may be blocked from making the purchase, or may have to undergo the test again. At 914, if it is determined that the eye pattern matches the known eye pattern within a threshold, the user passes the test, and may be allowed to make the purchase.

In yet another approach, rather than administering an eye-test, the AR system may periodically capture a picture of the AR user's eye, and perform an eye-identification by comparing the captured image of the user's eye with known information. In one or more embodiments, when the user is about to make a purchase, the AR device 62, 806 may request the user to stare at a particular virtual object presented to the user. This allows the user's eye to be still, and an image of the user's eye may be captured, and compared. If the picture of the eye correlates with a known picture of the user's eye, the AR user may be allowed to make the purchase. Further details on eye-identification techniques are provided in co-pending application 62/159,593, entitled “DEVICES, METHODS AND SYSTEMS FOR BIOMETRIC USER RECOGNITION UTILIZING NEURAL NETWORKS” under attorney docket no. ML 30028.00, which is herein incorporated by reference in its entirety.

Since the AR system generally needs to know where a user's eyes are gazing (or “looking”) and where the user's eyes are focused, this feature may be advantageously used for identification purposes. Thus in various embodiments, a head mounted display (“HMD”) component features one or more cameras that are oriented to capture image information pertinent to the user's eyes. In one configuration, such as that depicted in FIG. 5, each eye of the user may have a camera focused on it, along with three or more LEDs (in one embodiment directly below the eyes as shown) with known offset distances to the camera, to induce glints upon the surfaces of the eyes.

The presence of three or more LEDs with known offsets to each camera allows determination of the distance from the camera to each glint point in 3D space by triangulation. Using at least 3 glint points and an approximately spherical model of the eye, the system can deduce the curvature of the eye. With known 3D offset and orientation to the eye, the system can form exact (images) or abstract (gradients or other features) templates of the iris or retina for use to identify the user. In other embodiments, other characteristics of the eye, such as the pattern of veins in and over the eye, may also be used (e.g., along with the iris or retinal templates) to identify the user.

In one approach, an iris-image identification approach may be used. The pattern of muscle fibers in the iris of an eye forms a stable unique pattern for each person, including freckles, furrows and rings. Various iris features may be more readily captured using infrared or near-infrared imaging compared to visible light imaging. The system can transform the captured iris features into an identification code in many different ways. The goal is to extract a sufficiently rich texture from the eye. With sufficient degrees of freedom in the collected data, the system can theoretically identify a unique user.

In another approach, retina image identification may be similarly used. In one embodiment, the HMD comprises a diffraction display driven by a laser scanner steered by a steerable fiber optic cable. This fiber optic cable can also be utilized to visualize the interior of the eye and image the retina, which has a unique pattern of visual receptors (rods and cones) and blood vessels. These rods and cones may also form a pattern unique to each individual, and can be used to uniquely identify each person.

For instance, a pattern of dark and light blood vessels of each person is unique and can be transformed into a “dark-light” code by standard techniques such as applying gradient operators to the retinal image and counting high low transitions in a standardized grid centered at the center of the retina.

Thus the subject systems may be utilized to identify the user with enhanced accuracy and precision by comparing user characteristics captured or detected by the system with known baseline user characteristics for an authorized user of the system.

In yet other embodiments, a curvature/size of the eye may be similarly used. For example, this information may assist in identifying the user because eyes of different users are similar but not exactly the same. In other embodiments, temporal biometric information may be collected when the user is subjected to stress, and correlated to known data. For example, a user's heart rate may be monitored, whether the user's eyes are producing a water film, whether the eyes verge and focus together, breathing patterns, blink rates, pulse rate, etc. may be similarly used to confirm and/or invalidate the user's identity.

In yet other embodiments, to confirm the identity of the user (e.g., if mis-identity is suspected) the AR system may correlate information captured through the AR device (e.g., images of the surrounding environment captured through the field-of-view cameras of the AR device 62, 806) and determine whether the user is seeing the same scene that correlates to the location as derived from GPS and maps of the environment. For example, if the user is supposedly at home, the AR system may verify by correlated known objects of the user's home with what is being seen through the user's field-of-view cameras.

The above-described AR/user identification system provides an extremely secure form of user identification. In other words, the system may be utilized to determine who the user is with relatively high degrees of accuracy and precision. Since the system can be utilized to know who the user is with unusually high degree of certainty, and on a persistent basis (e.g., using periodic monitoring), it can be utilized to enable various financial transactions without the need for separate logins. One approach to ensure that the user identification system is highly accurate is through the use of neural networks, as is described in further detail in co-pending application 62/159,593 under Attorney Docket No. ML 30028.00, incorporated by reference above.

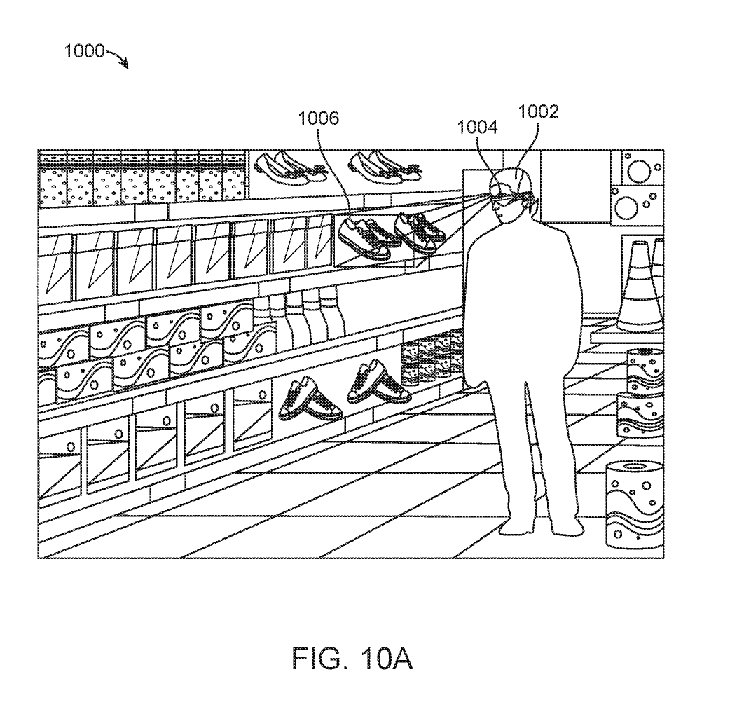

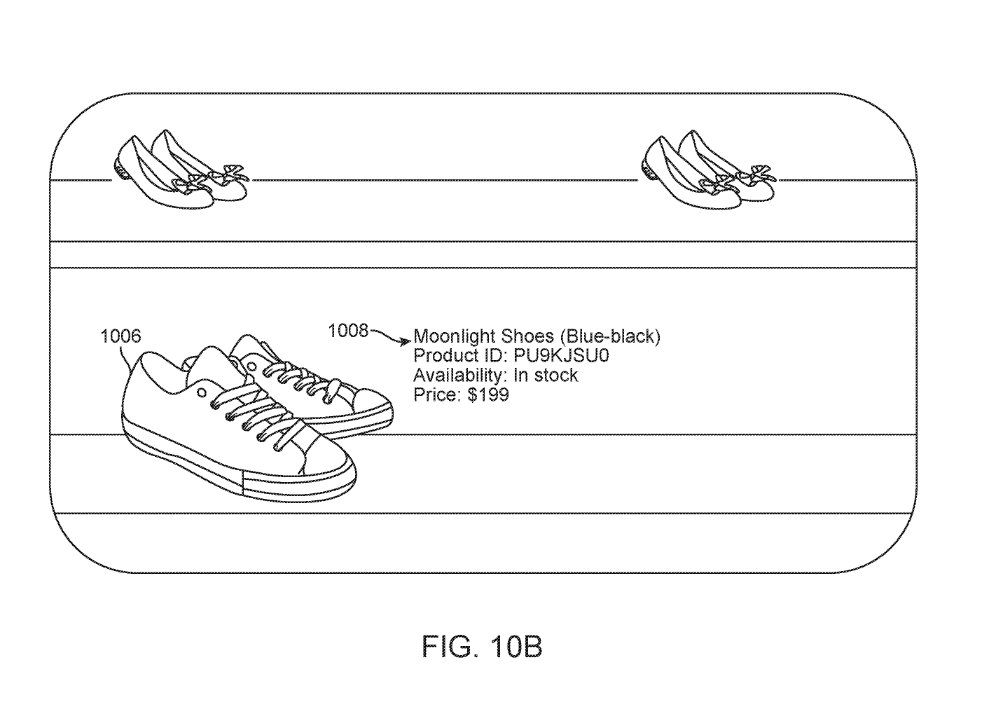

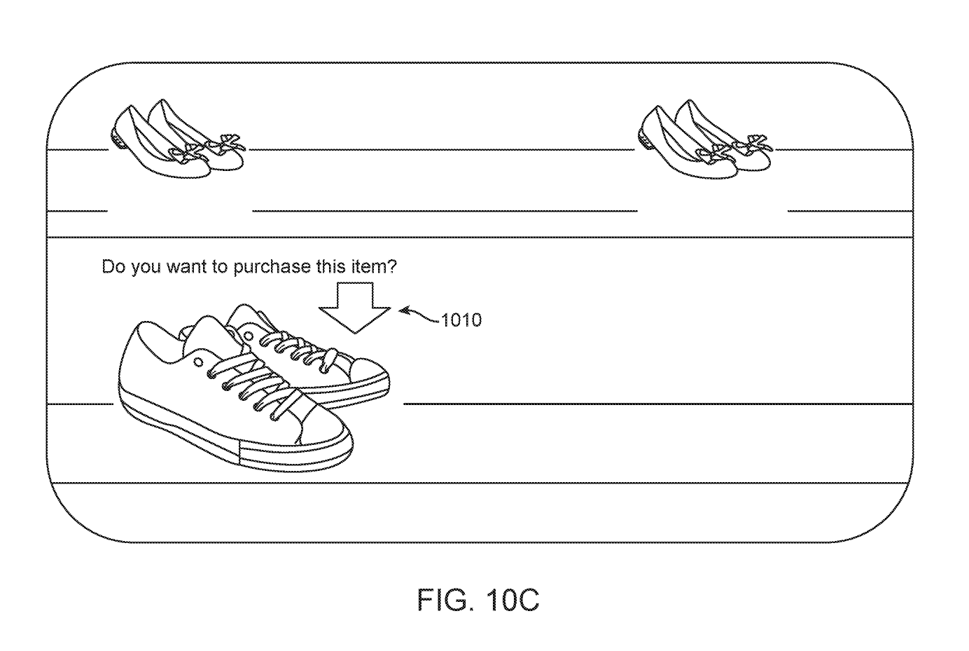

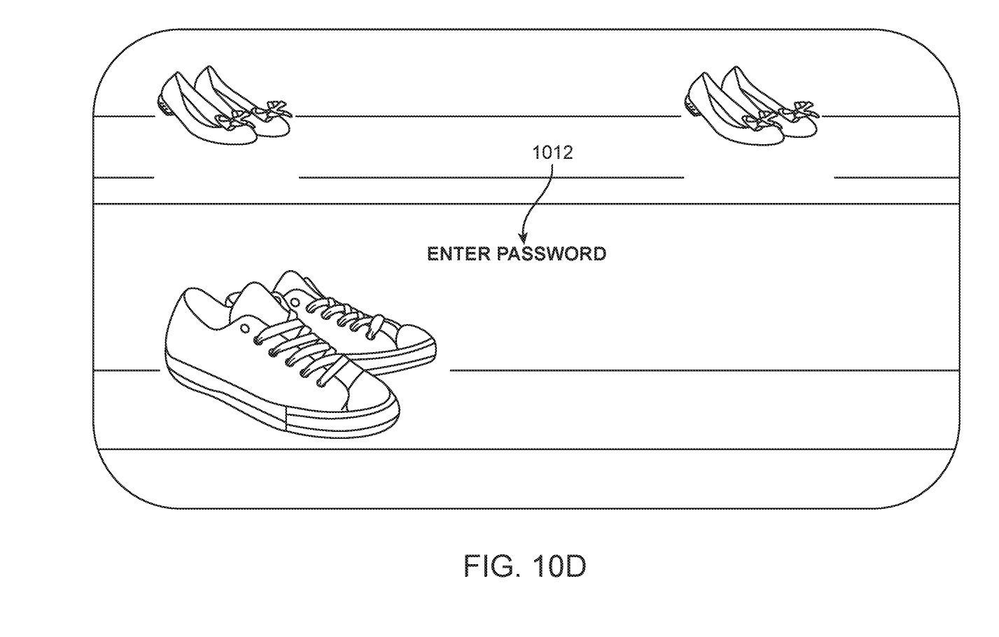

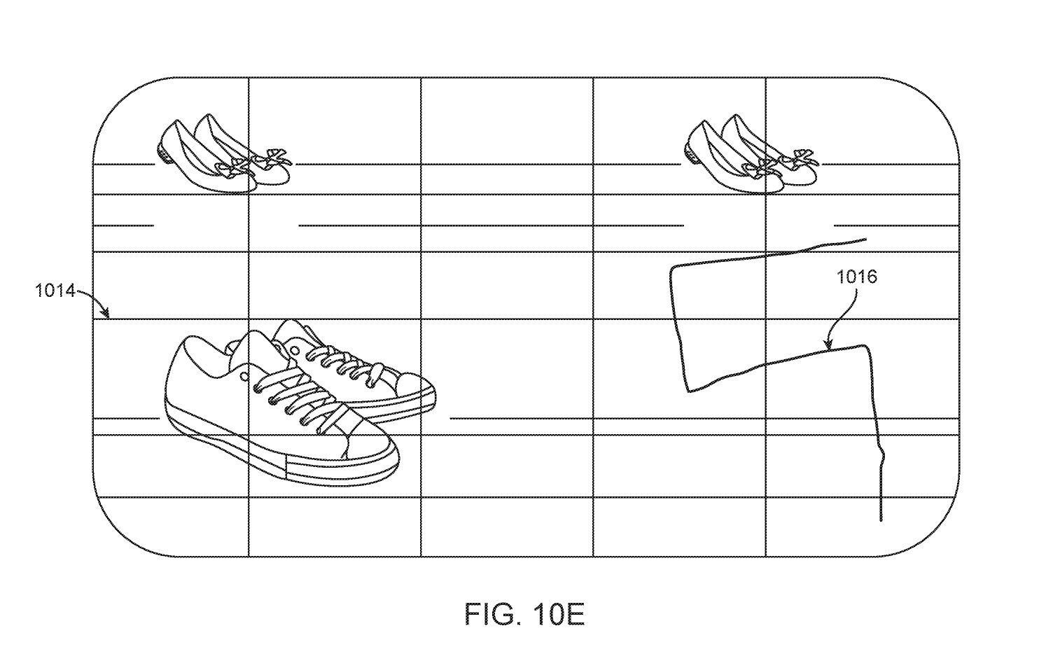

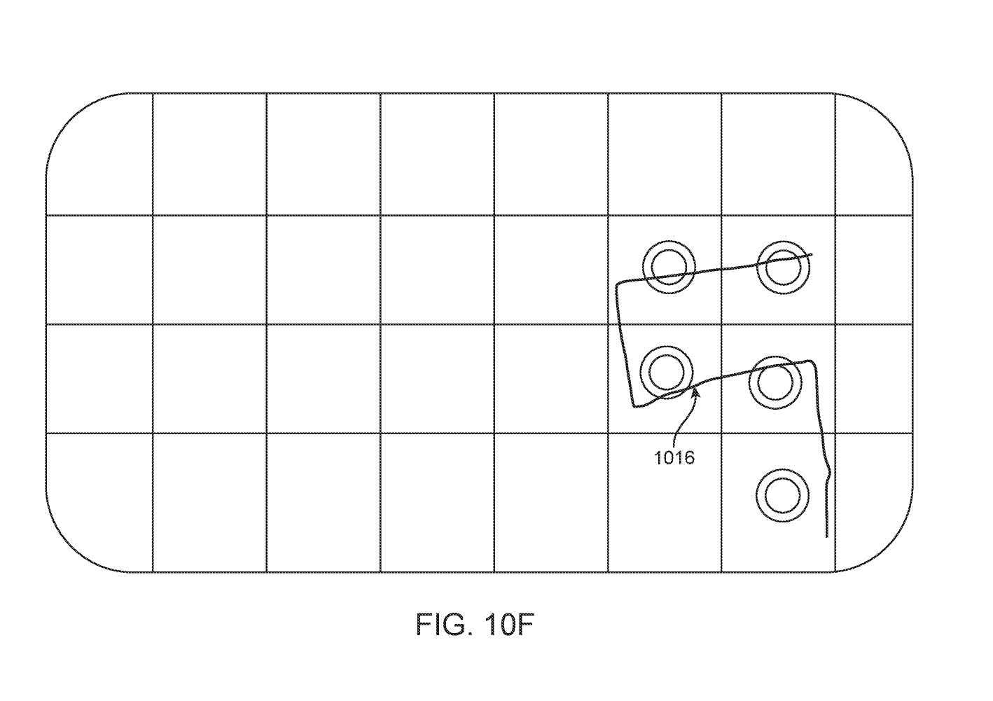

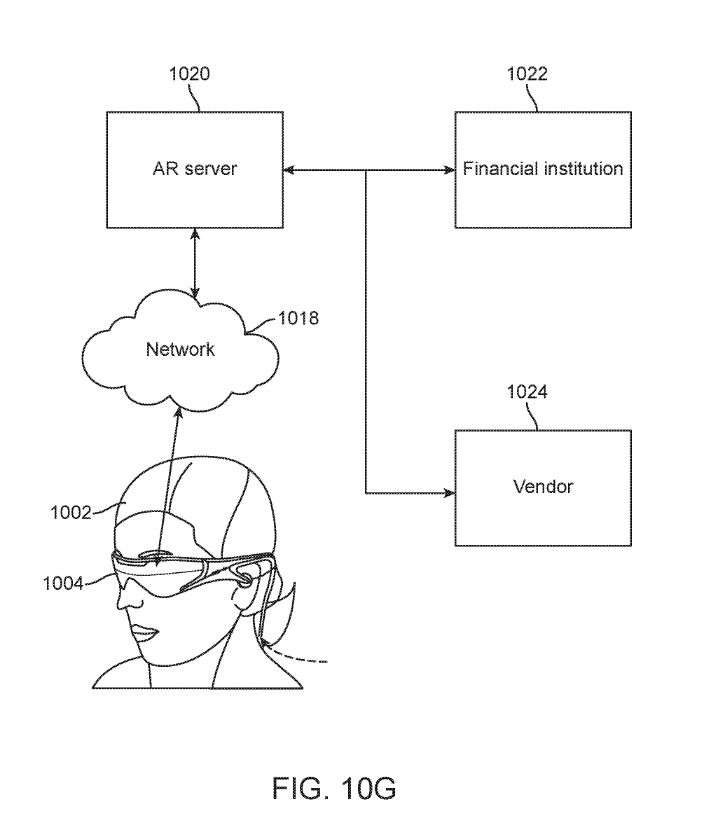

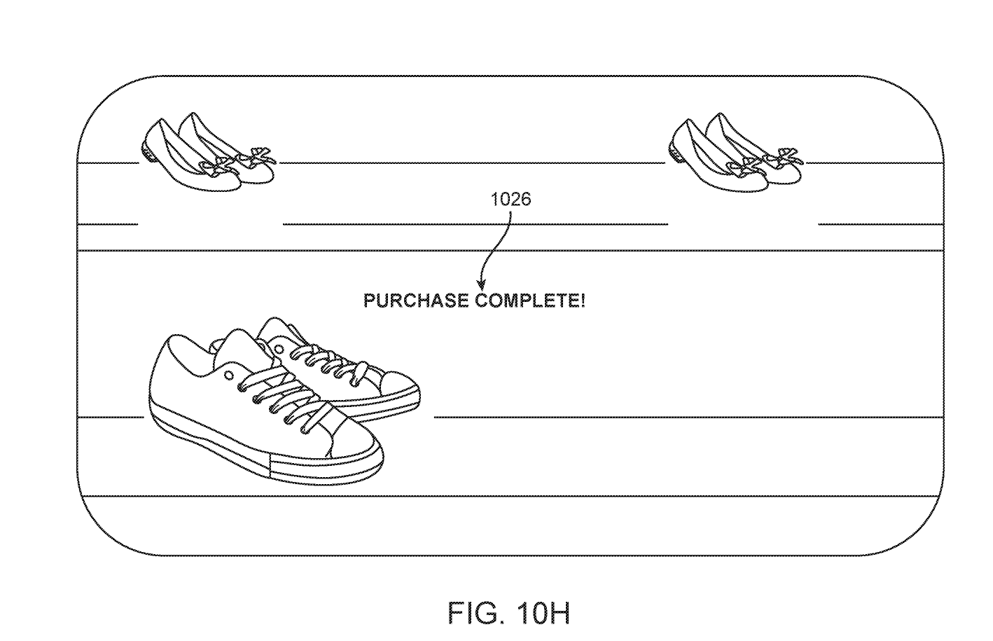

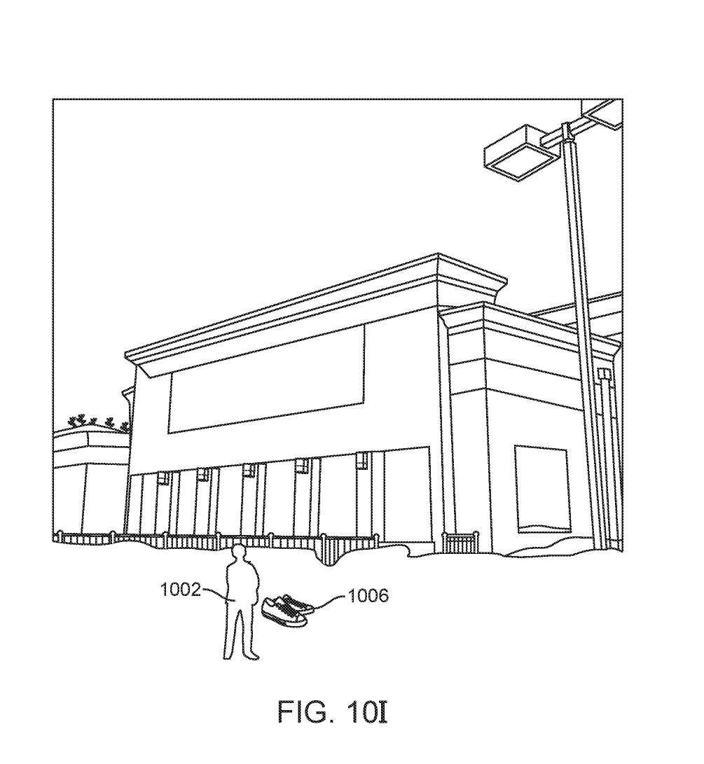

Referring now to FIGS. 10A-10I, an example process flow 1000 of using biometric data for conducting transactions is illustrated. As shown in FIG. 10A, a user 1002 wearing an AR device 1004 walks into a store. While at the store, the user 1002 may see a pair of shoes 1006 he may be interested in purchasing.

Referring now to FIG. 10B an example view of the shoes, as seen by the user 1002 through the AR device 1004 is shown. Detecting that the user's gaze is focused on the pair of shoes 1006, the AR device 1004 may look up details about the pair of shoes 1006 (e.g., through a product catalog synched to the AR device 1004, etc.), and display the details as virtual content 1008. Referring now to FIG. 100, the AR device 1004 may determine if the user wants to purchase an item by displaying virtual content 1010. The user 1002 may confirm or reject through any form of user input (e.g., gestures, voice, eye control, etc.).

Referring now to FIG. 10D, assuming the user confirmed the purchase, the AR device 1004 may request the password through virtual content 1012. At this point, as shown in FIG. 10E, the user 1002 may proceed to produce eye signature 1016. In one or more embodiments, a virtual grid 1014 may be presented to the user to aid in moving the eyes in a particular manner.

As shown in FIG. 10F, the inputted signature 1016 may be received by the AR system 1004, and compared to the predetermined signature to determine if the user is an authenticated user. If the user is authenticated, the AR device 1004, as shown in FIG. 10G may transmit data to the AR server 1020 through a network 1018 regarding the desired product to the vendor 1024 and a financial institution 1022. Based on the confirmation received from the AR server 1020, the financial institution 1022 may transmit the appropriate monetary amount to the vendor 1024.

As shown in FIG. 10H, once the transaction has been confirmed, the AR device 1004 may display virtual content 1026 confirming purchase of the shoes 1006. Having received confirmation, the user 1002 may walk out of the store with the desired shoes 1006, as shown in FIG. 101.

It should be appreciated that the process flow of FIGS. 10A-101 represents only an example embodiment that is presented here for illustrative purposes only and should not be read as limiting. Numerous other embodiments may be similarly envisioned. For example, in one or more embodiments, rather than requesting a “password” (e.g., FIG. 10D), the AR system may request the user to stare at a virtual dot on the screen, and capture an image of the user's eye (e.g., retina, iris, eye shape, etc.). This image may then be correlated to a known image of the user's eye, and the user's identity may be confirmed. Once the user's identity has been confirmed the AR system may transmit information to the vendor 1024 and the financial institution 1022 as shown in FIG. 10G. Similarly, many other similar embodiments may be envisioned.

As described above, it should be appreciated that such an authentication and payment system makes transactions much easier than traditional payment models. Rather than long and laborious trips to a department store, shopping becomes a “playground” experience, wherein users may simply walk into a store, pick up any number of products, and simply walk out of the store. The AR system takes care of most of the payment details, while only requiring a simple non-intrusive identification check based on easily tracked biometric data. As described above, identification checks according to some embodiments do not require any user action at the point of purchase.

As discussed in detail above, traditional passwords or sign up/login codes may be eliminated from individual secure transactions using the AR/user identification systems and methods described above. The subject system can pre-identify/pre-authenticate a user with a very high degree of certainty. Further, the system can maintain the identification of the user over time using periodic monitoring. Therefore, the identified user can have instant access to any site after a notice (that can be displayed as an overlaid user interface item to the user) about the terms of that site. In one embodiment the system may create a set of standard terms predetermined by the user, so that the user instantly knows the conditions on that site. If a site does not adhere to this set of conditions (e.g., the standard terms), then the subject system may not automatically allow access or transactions therein.

Additionally, the above-described AR/user identification systems can be used to facilitate “micro-transactions.” Micro-transactions which generate very small debits and credits to the user's financial account, typically on the order of a few cents or less than a cent. On a given site, the subject system may be configured to see that the user not only viewed or used some content but for how long (a quick browse might be free, but over a certain amount would be a charge). In various embodiments, a news article may cost ⅓ of a cent; a book may be charged at a penny a page; music at 10 cents a listen, and so on. In another embodiment, an advertiser may pay a user % a cent for selecting a banner ad or taking a survey. The system may be configured to apportion a small percentage of the transaction fee to the service provider.

In one embodiment, the system may be utilized to create a specific micro-transaction account, controllable by the user, in which funds related to micro-transactions are aggregated and distributed in predetermined meaningful amounts to/from the user's more traditional financial account (e.g., an online banking account). The micro-transaction account may be cleared or funded at regular intervals (e.g., quarterly) or in response to certain triggers (e.g., when the user exceeds several dollars spent at a particular website).

While micro-transactions are typically impractical and cumbersome in traditional payment paradigms, the ease with which transactions occur through almost-instantaneous user identification and authentication as described in the payment techniques described here removes many of the hurdles typically associated with micro-transactions. This may open up new avenues of monetization for upcoming businesses. For example, it might be easier to monetize music, books, advertisement etc. While users may be hesitant about paying a dollar for a news article, they may be less hesitant about an article that costs a fraction of a cent. Similarly, given that these transactions (micro and macros) are significantly easier to conduct, advertisers and publishers alike may be more likely to opening up content for different types of payment schemes. Thus, the AR system facilitates both payment and delivery of content, thereby making both the front-end and back-end process relatively painless.

Since the subject system and functionality may be provided by a company focused on augmented reality, and since the user's ID is very certainly and securely known, the user may be provided with instant access to their accounts, 3D view of amounts, spending, rate of spending and graphical and/or geographical map of that spending. Such users may be allowed to instantly adjust spending access, including turning spending (e.g., micro-transactions) off and on.

For macro-spending (i.e., amounts in dollars, not pennies or fraction of pennies), various embodiments may be facilitated with the subject system configurations.

The user may use the system to order perishable goods for delivery to their tracked location or to a user selected map location. The system can also notify the user when deliveries arrive (e.g., by displaying video of a delivery being made in the AR system). With AR telepresence, a user can be physically located in an office away from their house, but let a delivery person into their house, appear to the delivery person by avatar telepresence, watch the delivery person as they deliver the product, then make sure the delivery person leaves, and lock the door to their house by avatar.

Optionally, the system may store user product preferences and alert the user to sales or other promotions related to the user's preferred products. For these macro-spending embodiments, the user can see their account summary, all the statistics of their account and buying patterns, thereby facilitating comparison shopping before placing their order.

Since the system may be utilized to track the eye, it can also enable “one glance” shopping. For instance, a user may look at an object (say a robe in a hotel) and say, “I want that, when my account goes back over $3,000.” The system would execute the purchase when specific conditions (e.g., account balance greater than $3,000) are met.

As discussed above, in one or more embodiments, iris and/or retinal signature data may be used to secure communications. In such an embodiment, the subject system may be configured to allow text, image, and content to be transmittable selectively to and displayable only on trusted secure hardware devices, which allow access only when the user can be authenticated based on one or more dynamically measured iris and/or retinal signatures. Since the AR system display device projects directly onto the user's retina, only the intended recipient (identified by iris and/or retinal signature) may be able to view the protected content; and further, because the viewing device actively monitors the users eye, the dynamically read iris and/or retinal signatures may be recorded as proof that the content was in fact presented to the user's eyes (e.g., as a form of digital receipt, possibly accompanied by a verification action such as executing a requested sequence of eye movements).

Spoof detection may rule out attempts to use previous recordings of retinal images, static or 2D retinal images, generated images, etc. based on models of natural variation expected. A unique fiducial/watermark may be generated and projected onto the retinas to generate a unique retinal signature for auditing.

The above-described financial and communication systems are provided as examples of various common systems that can benefit from more accurate and precise user identification. Accordingly, use of the AR/user identification systems described herein is not limited to the disclosed financial and communication systems, but rather applicable to any system that requires user identification.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present invention. All such modifications are intended to be within the scope of claims associated with this disclosure.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A method of conducting a transaction through an augmented reality device, comprising:
capturing biometric data from a user;
determining, based at least in part on the captured biometric data, an identity of the user; and
authenticating the user for the transaction based on the determined identity.

2. The method of claim 1, further comprising transmitting a set of data regarding the transaction to a financial institution.

3. The method of claim 1, wherein the biometric data is an iris pattern.

4. The method of claim 1, wherein the biometric data is a voice recording of the user.

5. The method of claim 1, wherein the biometric data is a retinal signature.

6. The method of claim 1, wherein the biometric data is a characteristic associated with the user's skin.

7. The method of claim 1, wherein the biometric data is captured through one or more eye tracking cameras that capture a movement of the user's eyes.

8. The method of claim 1, wherein the biometric data is a pattern of movement of the user's eyes.

9. The method of claim 1, wherein the biometric data is a blinking pattern of the user's eyes.

10. The method of claim 1, wherein the augmented reality device is head mounted, and the augmented reality device is individually calibrated for the user.

11. The method of claim 1, wherein the biometric data is compared to a predetermined data pertaining to the user.

12. The method of claim 11, wherein the predetermined data is a known signature movement of the user's eyes.

13. The method of claim 11, wherein the predetermined data is a known iris pattern.

14. The method of claim 11, wherein the predetermined data is a known retinal pattern.

15. The method of claim 1, further comprising:
detecting a desire of the user to make a transaction;
requesting the biometric data from the user based at least in part on the detected desire;
comparing the biometric data with a predetermined biometric data to generate a result, wherein the user is authenticated based at least in part on the result.

16. The method of claim 1, wherein the transaction is a business transaction.

17. The method of claim 1, further comprising:
communicating an authentication of the user to a financial institution associated with the user, wherein the financial institution releases payment on behalf of the user based at least in part on the authentication.

18. The method of claim 17, wherein the financial institution transmits the payment to one or more vendors indicated by the user.

19. The method of claim 1, further comprising:
detecting an interruption event or transaction event associated with the augmented reality device; and
capturing new biometric data from the user in order to re-authenticate the user based at least in part on the detected event.

20. The method of claim 19, wherein the interruption of activity is detected based at least in part on a removal of the augmented reality device from the user's head.

21. The method of claim 19, wherein the interruption of activity is detected based at least in part on a loss of connectivity of the augmented reality device with a network.

22. The method of claim 19, wherein the transaction event is detected based at least in part on an express approval of a transaction by the user.

23. The method of claim 19, wherein the transaction event is detected based at least in part on a heat map associated with the user's gaze.

24. The method of claim 19, wherein the transaction event is detected based at least in part on user input received through the augmented reality device.

25. The method of claim 24, wherein the user input comprises an eye gesture.

26. The method of claim 24, wherein the user input comprises a hand gesture.

27. An augmented reality display system, comprising:
a biometric data tracking device to capture biometric data from a user;
a processor operatively coupled to the biometric data tracking device to process the captured biometric data, and to determine an identity of the user based at least in part on the captured biometric data; and
a server to communicate with at least a financial institution to authenticate the user for a transaction.

28. The augmented reality display system of claim 27, wherein the biometric data is eye movement data.

29. The augmented reality display system of claim 27, wherein the biometric data corresponds to an image of an iris of the user.

30. The augmented reality display system of claim 27, wherein the server also transmits a set of data regarding the transaction to a financial institution.

31. The augmented reality display system of claim 27, wherein the biometric data is an iris pattern.

32. The augmented reality display system of claim 27, wherein the biometric data is a voice recording of the user.

33. The augmented reality display system of claim 27, wherein the biometric data is a retinal signature.

34. The augmented reality display system of claim 27, wherein the biometric data is a characteristic associated with the user's skin.

35. The augmented reality display system of claim 27, wherein the biometric tracking device comprises one or more eye tracking cameras to capture a movement of the user's eyes.

36. The augmented reality display system of claim 27, wherein the biometric data is a pattern of movement of the user's eyes.

37. The augmented reality display system of claim 27, wherein the biometric data is a blinking pattern of the user's eyes.

38. The augmented reality display system of claim 27, wherein the augmented reality display system is head mounted, and the augmented reality display system is individually calibrated for the user.

39. The augmented reality display system of claim 27, wherein the processor also compares the biometric data to a predetermined data pertaining to the user.

40. The augmented reality display system of claim 39, wherein the predetermined data is a known signature movement of the user's eyes.

41. The augmented reality display system of claim 39, wherein the predetermined data is a known iris pattern.

42. The augmented reality display system of claim 39, wherein the predetermined data is a known retinal pattern.

43. The augmented reality display system of claim 27, wherein the processor detects that a user desires to make a transaction, and further comprising a user interface to request the biometric data from the user based at least in part on the detection, the processor comparing the biometric data with a predetermined biometric data, and authenticating the user based at least in part on the comparison.

44. The augmented reality display system of claim 27, wherein the transaction is a business transaction.

45. The augmented reality display system of claim 27, wherein the processor communicates the authentication of the user to a financial institution associated with the user, and wherein the financial institution releases payment on behalf of the user based at least in part on the authentication.

46. The augmented reality display system of claim 46, wherein the financial institution transmits the payment to one or more vendors indicated by the user.

47. The augmented reality display system of claim 27, wherein the processor detects an interruption event or transaction event associated with the augmented reality device, and wherein the biometric tracking device captures new biometric data from the user in order to re-authenticate the user based at least in part on the detected event.

48. The augmented reality display system of claim 47, wherein the interruption of activity is detected based at least in part on a removal of the augmented reality device from the user's head.

49. The augmented reality display system of claim 47, wherein the interruption of activity is detected based at least in part on a loss of connectivity of the augmented reality device with a network.

50. The augmented reality display system of claim 47, wherein the transaction event is detected based at least in part on an express approval of a transaction by the user.

51. The augmented reality display system of claim 47, wherein the transaction event is detected based at least in part on a heat map associated with the user's gaze.

52. The augmented reality display system of claim 47, wherein the transaction event is detected based at least in part on user input received through the augmented reality device.

53. The augmented reality display system of claim 52, wherein the user input comprises an eye gesture.

54. The augmented reality display system of claim 52, wherein the user input comprises a hand gesture.

55. The augmented reality display system of claim 27, wherein the biometric tracking device comprises an eye tracking system.

56. The augmented reality display system of claim 27, wherein the biometric tracking device comprises a haptic device.

57. The augmented reality display system of claim 27, wherein the biometric tracking device comprises a sensor that measures physiological data pertaining to a user's eye.
